(19) United States
(12) Patent Application Publication
(10) Pub. No.: US 2026/0101343 A1
(43) Pub. Date: Apr. 9, 2026

(54) METHOD AND APPARATUS OF UPLINK TRANSMISSION

(71) Applicant: Lenovo (Beijing) Limited, Beijing (CN)

(72) Inventors: Wei Ling, Beijing (CN); Yi Zhang, Beijing (CN); Chenxi Zhu, Beijing (CN); Bingchao Liu, Beijing (CN); Lingling Xiao, Beijing (CN)

(73) Assignee: Lenovo (Beijing) Limited, Beijing (CN)

(21) Appl. No.: 19/102,247

(22) PCT Filed: Aug. 11, 2022
(86) PCT No.: PCT/CN2022/111764

§ 371 Date: Feb. 7, 2025

(51) Int. Cl. H04W 72/21; H04B 7/0456; H04L 5/00

(52) U.S. Cl. CPC H04W 72/21; H04B 7/0486; H04L 5/0051

(57) ABSTRACT

Embodiments of the present application are related to a method and apparatus of uplink transmission. An exemplary method includes: transmitting first configuration information indicating two SRS resource sets for PUSCH transmissions; transmitting second configuration information including one or two configuration fields of indicating precoding information and layer number for a PUSCH, wherein the PUSCH is a PUSCH of a first scheme or a PUSCH of a scheme different from the first scheme; and receiving the PUSCH with precoding information determined at least according to the one or two configuration fields, a maximum SRS resource port number of the two SRS resource sets, a number of PUSCH antenna port for the PUSCH, a configured maximum rank for the PUSCH, and whether the PUSCH is the PUSCH of the first scheme or the PUSCH of a scheme different from the first scheme.

### TECHNICAL FIELD

Embodiments of the present application generally relate to wireless communication technology, especially to a method and an apparatus of uplink transmission, e.g., physical uplink shared channel (PUSCH).

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

Multi-transmit-receive point (TRP)/panel transmission has been introduced into NR since release 16 (Rel-16). For example, non-coherent joint transmission (NCJT) physical downlink shared channel (PDSCH) transmission was specified in R16. Similar to NCJT PDSCH, NCJT PUSCH transmission scheme (also referred to as NCJT PUSCH) is a typical transmission scheme when user equipment (UE) supports multi-panel simultaneous uplink (UL) transmission. However, there are a mass of issues on NCJT PUSCH transmission have not been solved. Thus, a work item description (WID) approved on multiple-input multiple-output (MIMO) in NR Rel-18 includes the following items to facilitate simultaneous multi-panel UL transmission for higher uplink throughput and better reliability, focusing on frequency range (FR)2 and multi-TRP (M-TRP), assuming up to 2 TRPs and up to 2 panels, and targeting customer premises equipment (CPE)/fixed wireless access (FWA)/vehicle/industrial devices (if applicable) as the following:
UL precoding indication for PUSCH, where no new codebook is introduced for multi-panel simultaneous transmission
   The total number of layers is up to four across all panels and total number of codewords is up to two across all panels, considering single downlink control information (DCI) and multi-DCI based multi-TRP operation.
UL beam indication for physical uplink control channel (PUCCH)/PUSCH, where unified transmission configuration information (TCI) framework extension in objective 2 is assumed, considering single DCI and multi-DCI based multi-TRP operation
   For the case of multi-DCI based multi-TRP operation, only PUSCH+PUSCH, or PUCCH+PUCCH is transmitted across two panels in a same carrier component (CC).

In addition, it is possible to support dynamic switching between or among different PUSCH schemes, such as, dynamic switching between single TRP (S-TRP) PUSCH (R15/16 PUSCH transmission) and NCJT PUSCH, or dynamic switching among S-TRP PUSCH, M-TRP PUSCH repetition (R17 PUSCH transmission) and NCJT PUSCH. Thus, when determining configuration related information of PUSCH, e.g., the bit width of precoding information and number of layers field, the UE side should also consider the dynamic switching.

### SUMMARY OF THE APPLICATION

One objective of the embodiments of the present application is to provide a technical solution of uplink transmission, especially, a method and an apparatus of uplink transmission supporting NCJT PUSCH.

Some embodiments of the present application provide a UE, which includes: a processor; and a transceiver coupled to the processor, wherein the transceiver is configured to: receive first configuration information indicating two sounding reference signal (SRS) resource sets for PUSCH transmissions; receive second configuration information including one or two configuration fields of indicating precoding information and layer number for a PUSCH, wherein the PUSCH is a PUSCH of a first scheme or a PUSCH of a scheme different from the first scheme, wherein in the case that the PUSCH is the PUSCH of the first scheme, a first set of layers of the PUSCH is associated with a first SRS resource set of the two SRS resource sets and a second set of layers of the PUSCH which are remaining layers except for the first set of layers of the PUSCH is associated with a second SRS resource set of the two SRS resource sets, and both a number of the first set of layers and a number of the second set of layers are equal to or larger than 1; and transmit the PUSCH with precoding information determined at least according to the one or two configuration fields, a maximum SRS resource port number of the two SRS resource sets, a number of PUSCH antenna port for the PUSCH, a configured maximum rank for the PUSCH, and whether the PUSCH is the PUSCH of the first scheme or the PUSCH of a scheme different from the first scheme.

Some other embodiments of the present application provide a method of uplink transmission, e.g., performed in a UE. The exemplary method includes: transmitting first configuration information indicating two SRS resource sets for PUSCH transmissions; transmitting second configuration information including one or two configuration fields of indicating precoding information and layer number for a PUSCH, wherein the PUSCH is a PUSCH of a first scheme or a PUSCH of a scheme different from the first scheme, wherein in the case that the PUSCH is the PUSCH of the first scheme, a first set of layers of the PUSCH is associated with a first SRS resource set of the two SRS resource sets and a second set of layers of the PUSCH which are remaining layers except for the first set of layers of the PUSCH is associated with a second SRS resource set of the two SRS resource sets, and both a number of the first set of layers and a number of the second set of layers are equal to or larger than 1; and receiving the PUSCH with precoding information determined at least according to the one or two configuration fields, a maximum SRS resource port number of the two SRS resource sets, a number of PUSCH antenna port for the PUSCH, a configured maximum rank for the PUSCH, and whether the PUSCH is the PUSCH of the first scheme or the PUSCH of a scheme different from the first scheme.

Some yet other embodiments of the present application provide a radio access network (RAN) node, e.g., a gNB, which includes: a processor; and a transceiver coupled to the processor, wherein the transceiver is configured to: transmit first configuration information indicating two SRS resource sets for PUSCH transmissions; transmit second configuration information including one or two configuration fields of indicating precoding information and layer number for a PUSCH, wherein the PUSCH is a PUSCH of a first scheme of a scheme different from the first scheme, wherein in the case that the PUSCH is the PUSCH of the first scheme, a first set of layers of the PUSCH is associated with a first SRS resource set of the two SRS resource sets and a second set of layers of the PUSCH which are remaining layers except for the first set of layers of the PUSCH is associated with a second SRS resource set of the two SRS resource sets, and both a number of the first set of layers and a number of the second set of layers are equal to or larger than 1; and receive the PUSCH, wherein the PUSCH is transmitted with precoding information determined at least according to the one or two configuration fields, a maximum SRS resource port number of the two SRS resource sets, a number of PUSCH antenna port for the PUSCH, a configured maximum rank for the PUSCH, and whether the PUSCH is the PUSCH of the first scheme or the PUSCH of a scheme different from the first scheme.

In some embodiments of the present application, in the case that the maximum SRS resource port number is 1, demodulation reference signal (DMRS) port for the PUSCH is determined from another configuration field of indicating DMRS port in the second configuration information, wherein, the DMRS port is determined for the PUSCH of the first scheme according to a rank of 2 and is determined for the PUSCH of scheme different from the first scheme according to a rank of 1.

In some embodiments of the present application, the maximum SRS resource port number and the number of PUSCH antenna port are 2, a real maximum rank for the PUSCH of the first scheme determined based on the configured maximum rank is 2, the PUSCH is the PUSCH in first scheme, and there is only one configuration field indicating a transmitted precoding matrix indicator (TPMI) index, the number of the first set of layers and the second set of layers of the PUSCH respectively, or there are two configuration fields but only one is a valid field for the PUSCH of the first scheme indicating the TPMI index, the number of the first set of layers and the number of the second set of layers of the PUSCH respectively, wherein, the TPMI index is one of TPMI index with 0-2 in Table 6.3.1.5-4 of TS38.211 for two-layer transmission using two antenna ports in the case that codebookSubset is configured to fullyAndPartialAndNonCoherent and ul-FullPowerTransmission is not configured or configured to fullpowerMode2 or configured to fullpower; or the TPMI index is one of TPMI index with 0 in Table 6.3.1.5-4 of TS38.211 for two-layer transmission using two antenna ports in the case that codebookSubset is configured to nonCoherent.

According to some embodiments of the present application, in the case that codebookSubset is configured to fullyAndPartialAndNonCoherent and ul-FullPowerTransmission is not configured or configured to fullpowerMode2 or configured to fullpower, a bit width of the only one configuration field or the valid field is 2; or in the case that codebookSubset is configured to nonCoherent, the bit width of the only one configuration field or the valid field is 0.

In some embodiments of the present application, the maximum SRS resource port number and the number of PUSCH antenna port are 2, a real maximum rank for the PUSCH of the first scheme determined based on the configured maximum rank is 2, and the PUSCH is the PUSCH of the first scheme, and there are two configuration fields, a first field of the two configuration fields indicates the number of the first set of layers and a first transmitted TPMI index for the first set of layers and a second field of the two configuration fields indicates the number of the second set of layers and a second TPMI index for the second set of layers, wherein, in the case that codebookSubset is configured to fullyAndPartialAndNonCoherent and ul-FullPowerTransmission is not configured or configured to fullpowerMode2 or configured to fullpower, each of the first and second the TPMI index is one of TPMI index with 0-5 in Table 6.3.1.5-1 of TS38.211 for single-layer transmission using two antenna ports; in the case that codebookSubset is configured to nonCoherent and ul-FullPowerTransmission is not configured or configured to fullpowerMode2 or configured to fullpower, each of the first and second the TPMI index is one of TPMI index with 0-1 in Table 6.3.1.5-1 of TS38.211 for single-layer transmission using two antenna ports; or in the case that codebookSubset is configured to nonCoherent and ul-FullPowerTransmission is configured to fullpowerModel, each of the first and second the TPMI index is one of TPMI index with 0-2 in Table 6.3.1.5-1 of TS38.211 for single-layer transmission using two antenna ports.

According to some embodiments of the present application, in the case that codebookSubset is configured to fullyAndPartialAndNonCoherent and ul-FullPowerTransmission is not configured or configured to fullpowerMode2 or configured to fullpower, a bit width of each configuration field is 3; or in the case that codebookSubset is configured to nonCoherent and ul-FullPowerTransmission is not configured or configured to fullpowerMode2 or configured to fullpower, the bit width of each configuration field is 1; or in the case that codebookSubset is configured to nonCoherent and ul-FullPowerTransmission is configured to fullpowerModel, the bit width of each configuration field is 2.

In some embodiments of the present application, the maximum SRS resource port number is 2, the number of PUSCH antenna port is 4, the PUSCH is the PUSCH of the first scheme, wherein a first PUSCH antenna port and a third PUSCH antenna port are two SRS resource ports of a first associated SRS resource of the PUSCH within the first SRS resource set of the two SRS resource sets for transmitting the first set of layers of the PUSCH, and a second PUSCH antenna port and a fourth PUSCH antenna port are two SRS resource ports of a second associated SRS resource of the PUSCH within the second SRS resource set of the two SRS resource sets for transmitting the second set of layers of the PUSCH.

According to some embodiments of the present application, there is only one configuration field or there are two configuration fields but only one is a valid field for the PUSCH of the first scheme, and the only one configuration field or the valid field indicates a TPMI index and also indicates the number of the first set of layers and the second set of layers of the PUSCH respectively, wherein:
in the case that codebookSubset is configured to fullyAndPartialAndNonCoherent, ul-FullPowerTransmission is not configured or configured to fullpowerMode2 or configured to fullpower, and
   in the case of a real maximum rank for the PUSCH of the first scheme determined based on the configured maximum rank being 2, the TPMI index is one of TPMI index with 0, 2, 5-13 in Table 6.3.1.5-5 of TS38.211 for two-layer transmission using four antenna ports;
   in the case of a real maximum rank for the PUSCH of the first scheme determined based on the configured maximum rank being 3, the TPMI index is one of TPMI index with 0, 2, 5-13 in Table 6.3.1.5-5 of TS38.211 for two-layer transmission using four antenna ports and TPMI index with 1-2 in Table 6.3.1.5-6 of TS38.211 for three-layer transmission using four antenna ports; or
   in the case of a real maximum rank for the PUSCH of the first scheme determined based on the configured maximum rank being 4, the TPMI index is one of TPMI index with 0, 2, 5-13 in Table 6.3.1.5-5 of TS38.211 for two-layer transmission using four antenna ports, TPMI index with 1-2 in Table 6.3.1.5-6 of TS38.211 for three-layer transmission using four antenna ports and TPMI index with 1-2 in Table 6.3.1.5-7 of TS38.211 for four-layer transmission using four antenna ports; or
in the case that codebookSubset is configured to nonCoherent, ul-FullPowerTransmission is not configured or configured to fullpowerMode2 or configured to fullpower, and
   in the case of a real maximum rank for the PUSCH of the first scheme determined based on the configured maximum rank being 2, the TPMI index is one of TPMI index with 0, 2 and 5 in Table 6.3.1.5-5 of TS38.211 for two-layer transmission using four antenna ports;
   in the case of a real maximum rank for the PUSCH of the first scheme determined based on the configured maximum rank being 3, the TPMI index is one of TPMI index with 0, 2 and 5 in Table 6.3.1.5-5 of TS38.211 for two-layer transmission using four antenna ports; or
   in the case of a real maximum rank for the PUSCH of the first scheme determined based on the configured maximum rank being 4, the TPMI index is one of TPMI index with 0, 2 and 5 in Table 6.3.1.5-5 of TS38.211 for two-layer transmission using four antenna ports; or in the case that codebookSubset is configured to nonCoherent, ul-FullPowerTransmission is configured to fullpowerModel, and
in the case of a real maximum rank for the PUSCH of the first scheme determined based on the configured maximum rank being 2, the TPMI index is one of TPMI index with 0, 2, 5 and 6 with in Table 6.3.1.5-5 of TS38.211 for two-layer transmission using four antenna ports;
   in the case of a real maximum rank for the PUSCH of the first scheme determined based on the configured maximum rank being 3, the TPMI index is one of TPMI index with 0, 2, 5 and 6 with in Table 6.3.1.5-5 of TS38.211 for two-layer transmission using four antenna ports and TPMI index with 1 in Table 6.3.1.5-6 of TS38.211 for three-layer transmission using four antenna ports; or
   in the case of a real maximum rank for the PUSCH of the first scheme determined based on the configured maximum rank being 4, the TPMI index is one of TPMI index with 0, 2, 5 and 6 with in Table 6.3.1.5-5 of TS38.211 for two-layer transmission using four antenna ports and TPMI index with 1 in Table 6.3.1.5-6 of TS38.211 for three-layer transmission using four antenna ports.

Regarding the exemplary bit width of the only one field or the valid field, it is as follows:
in the case that codebookSubset is configured to fullyAndPartialAndNonCoherent, ul-FullPowerTransmission is not configured or configured to fullpowerMode2 or configured to fullpower, and
   in the case of a real maximum rank for the PUSCH of the first scheme determined based on the configured maximum rank being 2, a bit width of the only one configuration field or the valid field is 4;
   in the case of a real maximum rank for the PUSCH of the first scheme determined based on the configured maximum rank being 3, the bit width of the field only one configuration field or the valid field is 5;
   in the case of a real maximum rank for the PUSCH of the first scheme determined based on the configured maximum rank being 4, the bit width of the only one field or the valid field is 6; or
in the case that codebookSubset is configured to nonCoherent, ul-FullPowerTransmission is not configured or configured to fullpowerMode2 or configured to fullpower, and
   in the case of a real maximum rank for the PUSCH of the first scheme determined based on the configured maximum rank being 2, the bit width of the only one configuration field or the valid field is 2;
   in the case of a real maximum rank for the PUSCH of the first scheme determined based on the configured maximum rank being 3, the bit width of the only one configuration field or the valid field is 2; or
   in the case of a real maximum rank for the PUSCH of the first scheme determined based on the configured maximum rank being 4, the bit width of the only one configuration field or the valid field is 2; or
in the case that codebookSubset is configured to nonCoherent, ul-FullPowerTransmission is configured to fullpowerModel, and
   in the case of a real maximum rank for the PUSCH of the first scheme determined based on the configured maximum rank being 2, the bit width of the only one configuration field or the valid field is 2;
   in the case of a real maximum rank for the PUSCH of the first scheme determined based on the configured maximum rank being 3, the bit width of the only one configuration field or the valid field is 4; or
   in the case of a real maximum rank for the PUSCH of the first scheme determined based on the configured maximum rank being 4, the bit width of the only one configuration field or the valid field is 4.

According to some other embodiments of the present application, there are two configuration fields, a first field of the two configuration fields indicates the number of the first set of layers and a first TPMI index for the first set of layers and a second field of the two configuration fields indicates the number of the first set of layers and a second TPMI index for the second set of layers, wherein:
in the case that codebookSubset is configured to fullyAndPartialAndNonCoherent, ul-FullPowerTransmission is not configured or configured to fullpowerMode2 or configured to fullpower, and
   in the case of a real maximum rank for the PUSCH of the first scheme determined based on the configured maximum rank being 2, the first TPMI index is one of TPMI index with 0, 2, and 4-7 in Table 6.3.1.5-3 of TS38.211 for single-layer transmission using four antenna ports, and the second TPMI index is one of TPMI index 1, 3 and 8-11 in Table 6.3.1.5-3 of TS38.211 for single-layer transmission using four antenna ports; or
   in the case of a real maximum rank for the PUSCH of the first scheme determined based on the configured maximum rank being 3 or 4, the first TPMI index is one of TPMI index with 0, 2, and 4-7 in Table 6.3.1.5-3 of TS38.211 for single-layer transmission using four antenna ports and TPMI index with 1 in Table 6.3.1.5-5 of TS38.211 for two-layer transmission using four antenna ports, and the second TPMI index is one of TPMI index 1, 3 and 8-11 in Table 6.3.1.5-3 of TS38.211 for single-layer transmission using four antenna ports and TPMI index with 4 in Table 6.3.1.5-5 of TS38.211 for two-layer transmission using four antenna ports;
in the case that codebookSubset is configured to nonCoherent, ul-FullPowerTransmission is not configured or configured to fullpowerMode2 or configured to fullpower, and
   in the case of a real maximum rank for the PUSCH of the first scheme determined based on the configured maximum rank being 2, the first TPMI index is one of TPMI index with 0 and 2 in Table 6.3.1.5-3 of TS38.211 for single-layer transmission using four antenna ports, and the second TPMI index is one of TPMI index 1 and 3 in Table 6.3.1.5-3 of TS38.211 for single-layer transmission using four antenna ports; or
   in the case of a real maximum rank for the PUSCH of the first scheme determined based on the configured maximum rank being 3 or 4, the first TPMI index is one of TPMI index with 0 and 2 in Table 6.3.1.5-3 of TS38.211 for single-layer transmission using four antenna ports and TPMI index with 1 in Table 6.3.1.5-5 of TS38.211 for two-layer transmission using four antenna ports, and the second TPMI index is one of TPMI index 1 and 3 in Table 6.3.1.5-3 of TS38.211 for single-layer transmission using four antenna ports and TPMI index with 4 in Table 6.3.1.5-5 of TS38.211 for two-layer transmission using four antenna ports; or
in the case that codebookSubset is configured to nonCoherent, ul-FullPowerTransmission is configured to fullpowerModel, and
   in the case of a real maximum rank for the PUSCH of the first scheme determined based on the configured maximum rank being 2, the first TPMI index is one of TPMI index with 0 and 2 in Table 6.3.1.5-3 of TS38.211 for single-layer transmission using four antenna ports, and the second TPMI index is one of TPMI index 1 and 3 in Table 6.3.1.5-3 of TS38.211 for single-layer transmission using four antenna ports; or
   in the case of a real maximum rank for the PUSCH of the first scheme determined based on the configured maximum rank being 3 or 4, the first TPMI index is one of TPMI index with 0 and 2 in Table 6.3.1.5-3 of TS38.211 for single-layer transmission using four antenna ports and TPMI index with 1 in Table 6.3.1.5-5 of TS38.211 for two-layer transmission using four antenna ports, and the second TPMI index is one of TPMI index 1 and 3 in Table 6.3.1.5-3 of TS38.211 for single-layer transmission using four antenna ports and TPMI index with 4 in Table 6.3.1.5-5 of TS38.211 for two-layer transmission using four antenna ports.

Regarding the exemplary bit width of each configuration field, it is as follows:
in the case that codebookSubset is configured to fullyAndPartialAndNonCoherent, ul-FullPowerTransmission is not configured or configured to fullpowerMode2 or configured to fullpower, and
   in the case of a real maximum rank for the PUSCH of the first scheme determined based on the configured maximum rank being 2, a bit width of each configuration field is 3;
   in the case of a real maximum rank for the PUSCH of the first scheme determined based on the configured maximum rank being 3 or 4, the bit width of each configuration field is 3; or
in the case that codebookSubset is configured to nonCoherent, ul-FullPowerTransmission is not configured or configured to fullpowerMode2 or configured to fullpower, and
   in the case of a real maximum rank for the PUSCH of the first scheme determined based on the configured maximum rank being 2, the bit width of each configuration field is 1;
   in the case of a real maximum rank for the PUSCH of the first scheme determined based on the configured maximum rank being 2, the bit width of each configuration field is 2; or
in the case that codebookSubset is configured to nonCoherent, ul-FullPowerTransmission is configured to fullpowerModel, and
   in the case of a real maximum rank for the PUSCH of the first scheme determined based on the configured maximum rank being 2, the bit width of each configuration field is 1; or
   in the case of a real maximum rank for the PUSCH of the first scheme determined based on the configured maximum rank being 3 or 4, the bit width of each configuration field is 2.

In some embodiments of the present application, the maximum SRS resource port number is 2, the number of PUSCH antenna port is 4, and the PUSCH is the PUSCH of the first scheme, wherein two PUSCH antenna ports are two SRS resource ports of the first associated SRS resource of the PUSCH within the first SRS resource set of the two SRS resource sets for transmitting the first set of layers of the PUSCH, and remaining two PUSCH antenna ports are two SRS resource ports of a second associated SRS resource of the PUSCH within the second SRS resource set of the two SRS resource sets for transmitting a second set of layers of the PUSCH.

According to some embodiments of the present application, there is only one configuration field or there are two configuration fields but only one is a valid field for the PUSCH of the first scheme, the only one configuration field or the valid field indicates a TPMI index and also indicates the number of the first set of layers and the number of the second set of layers of the PUSCH respectively, wherein:
in the case that codebookSubset is configured to fullyAndPartialAndNonCoherent, ul-FullPowerTransmission is not configured or configured to fullpowerMode2 or configured to fullpower, and
   in the case of a real maximum rank for the PUSCH of the first scheme determined based on the configured maximum rank being 2, the TPMI index is one of TPMI index with 0-13 in Table 6.3.1.5-5 of TS38.211 for two-layer transmission using four antenna ports;
   in the case of a real maximum rank for the PUSCH of the first scheme determined based on the configured maximum rank being 3, the TPMI index is one of TPMI index with 0-13 in Table 6.3.1.5-5 of TS38.211 for two-layer transmission using four antenna ports and TPMI index with 0-2 in Table 6.3.1.5-6 of TS38.211 for three-layer transmission using four antenna ports; or
   in the case of a real maximum rank for the PUSCH of the first scheme determined based on the configured maximum rank being 4, the TPMI index is one of TPMI index with 0-13 in Table 6.3.1.5-5 of TS38.211 for two-layer transmission using four antenna ports, TPMI index with 0-2 in Table 6.3.1.5-6 of TS38.211 for three-layer transmission using four antenna ports and TPMI index with 0-2 in Table 6.3.1.5-7 of TS38.211 for four-layer transmission using four antenna ports;
in the case that codebookSubset is configured to nonCoherent, ul-FullPowerTransmission is not configured or configured to fullpowerMode2 or configured to fullpower, and
   in the case of a real maximum rank for the PUSCH of the first scheme determined based on the configured maximum rank being 2, the TPMI index is one of TPMI index with 0-5 in Table 6.3.1.5-5 of TS38.211 for two-layer transmission using four antenna ports;
   in the case of a real maximum rank for the PUSCH of the first scheme determined based on the configured maximum rank being 3, the TPMI index is one of TPMI index with 0-5 in Table 6.3.1.5-5 of TS38.211 for two-layer transmission using four antenna ports and TPMI index with 0 in Table 6.3.1.5-6 of TS38.211 for three-layer transmission using four antenna ports;
   in the case of a real maximum rank for the PUSCH of the first scheme determined based on the configured maximum rank being 4, the TPMI index is one of TPMI index with 0-5 in Table 6.3.1.5-5 of TS38.211 for two-layer transmission using four antenna ports, TPMI index with 0 in Table 6.3.1.5-6 of TS38.211 for three-layer transmission using four antenna ports, and TPMI index with 0 in Table 6.3.1.5-7 of TS38.211 for four-layer transmission using four antenna ports; or
in the case that codebookSubset is configured to nonCoherent, ul-FullPowerTransmission is configured to fullpowerModel, and
   in the case of a real maximum rank for the PUSCH of the first scheme determined based on the configured maximum rank being 2, the TPMI index is one of TPMI index with 0-6 with in Table 6.3.1.5-5 of TS38.211 for two-layer transmission using four antenna ports;
   in the case of a real maximum rank for the PUSCH of the first scheme determined based on the configured maximum rank being 3, the TPMI index is one of TPMI index with 0-6 with in Table 6.3.1.5-5 of TS38.211 for two-layer transmission using four antenna ports and TPMI index with 0-1 in Table 6.3.1.5-6 of TS38.211 for three-layer transmission using four antenna ports; or
   in the case of a real maximum rank for the PUSCH of the first scheme determined based on the configured maximum rank being 4, the TPMI index is one of TPMI index with 0-6 with in Table 6.3.1.5-5 of TS38.211 for two-layer transmission using four antenna ports, TPMI index with 0-1 in Table 6.3.1.5-6 of TS38.211 for three-layer transmission using four antenna ports and TPMI index with 0 in Table 6.3.1.5-7 of TS38.211 for four-layer transmission using four antenna ports.

Regarding the exemplary bit width of the only one field or the valid field, it is as follows:
in the case that codebookSubset is configured to fullyAndPartialAndNonCoherent, ul-FullPowerTransmission is not configured or configured to fullpowerMode2 or configured to fullpower, and
   in the case of a real maximum rank for the PUSCH of the first scheme determined based on the configured maximum rank being 2, a bit width of the only one configuration field or the valid field is 4;
   in the case of a real maximum rank for the PUSCH of the first scheme determined based on the configured maximum rank being 3, the bit width of the only one configuration field or the valid field is 7; or
   in the case of a real maximum rank for the PUSCH of the first scheme determined based on the configured maximum rank being 4, the bit width of the only one configuration field or the valid field is 7;
in the case that codebookSubset is configured to nonCoherent, ul-FullPowerTransmission is not configured or configured to fullpowerMode2 or configured to fullpower, and
   in the case of a real maximum rank for the PUSCH of the first scheme determined based on the configured maximum rank being 2, a bit width of the only one configuration field or the valid field is 3;
   in the case of a real maximum rank for the PUSCH of the first scheme determined based on the configured maximum rank being 3, the bit width of the only one configuration field or the valid field is 5; or
   in the case of a real maximum rank for the PUSCH of the first scheme determined based on the configured maximum rank being 4, the bit width of the only one configuration field or the valid field is 5;
in the case that codebookSubset is configured to nonCoherent, ul-FullPowerTransmission is configured to fullpowerMode1, and
   in the case of a real maximum rank for the PUSCH of the first scheme determined based on the configured maximum rank being 2, the bit width of the only one configuration field or the valid field is 3;
   in the case of a real maximum rank for the PUSCH of the first scheme determined based on the configured maximum rank being 3, the bit width of the only one configuration field or the valid field is 6; or
   in the case of a real maximum rank for the PUSCH of the first scheme determined based on the configured maximum rank being 4, the bit width of the only one configuration field or the valid field is 6.

According to some other embodiments of the present application, there are two configuration fields, a first field of the two configuration fields indicates the number of the first set of layers and a first TPMI index for the first set of layers and a second field of the two configuration fields indicates the number of the second set of layers and a second TPMI index for the second set of layers, wherein:
in the case that codebookSubset is configured to fullyAndPartialAndNonCoherent, ul-FullPowerTransmission is not configured or configured to fullpowerMode2 or configured to fullpower, and
   in the case of a real maximum rank for the PUSCH of the first scheme determined based on the configured maximum rank being 2, each of the first TPMI index and the second TPMI index is one of TPMI index with 0-11 in Table 6.3.1.5-3 of TS38.211 for single-layer transmission using four antenna ports; or
   in the case of a real maximum rank for the PUSCH of the first scheme determined based on the configured maximum rank being 3 or 4, each of the first TPMI index and the second TPMI index is one of TPMI index with 0-11 in Table 6.3.1.5-3 of TS38.211 for single-layer transmission using four antenna ports and TPMI index with 0-5 in Table 6.3.1.5-5 of TS38.211 for two-layer transmission using four antenna ports;
in the case that codebookSubset is configured to nonCoherent, ul-FullPowerTransmission is not configured or configured to fullpowerMode2 or configured to fullpower,
   in the case of a real maximum rank for the PUSCH of the first scheme determined based on the configured maximum rank being 2, each of the first TPMI index and the second TPMI index is one of TPMI index with 0-3 in Table 6.3.1.5-3 of TS38.211 for single-layer transmission using four antenna ports; or
   in the case of a real maximum rank for the PUSCH of the first scheme determined based on the configured maximum rank being 3 or 4, each of the first TPMI index and the second TPMI index is one of TPMI index with 0-3 in Table 6.3.1.5-3 of TS38.211 for single-layer transmission using four antenna ports, and TPMI index with 0-5 in Table 6.3.1.5-5 of TS38.211 for two-layer transmission using four antenna ports; or
in the case that codebookSubset is configured to nonCoherent, ul-FullPowerTransmission is configured to fullpowerModel, and
   in the case of a real maximum rank for the PUSCH of the first scheme determined based on the configured maximum rank being 2, each of the first TPMI index and the second TPMI index is one of TPMI index 0-3 in Table 6.3.1.5-3 of TS38.211 for single-layer transmission using four antenna ports; or
   in the case of a real maximum rank for the PUSCH of the first scheme determined based on the configured maximum rank being 3 or 4, each of the first TPMI index and the second TPMI index is TPMI index with 0-3 in Table 6.3.1.5-3 of TS38.211 for single-layer transmission using four antenna ports and TPMI index with 0-5 in Table 6.3.1.5-5 of TS38.211 for two-layer transmission using four antenna ports.

Regarding the exemplary bit width of each configuration field, it is as follows:
in the case that codebookSubset is configured to fullyAndPartialAndNonCoherent, ul-FullPowerTransmission is not configured or configured to fullpowerMode2 or configured to fullpower, and
   in the case of a real maximum rank for the PUSCH of the first scheme determined based on the configured maximum rank being 2, a bit width of each configuration field is 4;
   in the case of a real maximum rank for the PUSCH of the first scheme determined based on the configured maximum rank being 3 or 4, the bit width of each configuration field is 5; or
in the case that codebookSubset is configured to nonCoherent, ul-FullPowerTransmission is not configured or configured to fullpowerMode2 or configured to fullpower, and
   in the case of a real maximum rank for the PUSCH of the first scheme determined based on the configured maximum rank being 2, the bit width of each configuration field is 2; or
   in the case of a real maximum rank for the PUSCH of the first scheme determined based on the configured maximum rank being 3 or 4, the bit width of each configuration field is 4;
in the case that codebookSubset is configured to nonCoherent, ul-FullPowerTransmission is configured to fullpowerModel, and
   in the case of a real maximum rank for the PUSCH of the first scheme determined based on the configured maximum rank being 2, the bit width of each configuration field is 2; or
   in the case of a real maximum rank for the PUSCH of the first scheme determined based on the configured maximum rank being 3 or 4, the bit width of each configuration field is 4.

In some embodiments of the present application, the maximum SRS resource port number is 2, the number of PUSCH antenna port is 4, the PUSCH is the PUSCH of the first scheme, wherein a first PUSCH antenna port and a second PUSCH antenna port are two SRS resource ports of a first associated SRS resource of the PUSCH within the first SRS resource set of the two SRS resource sets for transmitting the first set of layers of the PUSCH, and a third PUSCH antenna port and a fourth PUSCH antenna port are two SRS resource ports of the second associated SRS resource of the PUSCH within a second SRS resource set of the two SRS resource sets for transmitting the second set of layers of the PUSCH.

According to some embodiments of the present application, there are two configuration fields, a first field of the two configuration fields indicates the number of the first set of layers and a first TPMI index for the first set of layers and a second field of the two configuration fields indicates the number of the first set of layers and a second TPMI index for the second set of layers, wherein:
in the case that codebookSubset is configured to fullyAndPartialAndNonCoherent, ul-FullPowerTransmission is not configured or configured to fullpowerMode2 or configured to fullpower, and
   in the case of a real maximum rank for the PUSCH of the first scheme determined based on the configured maximum rank being 2, each of the first TPMI index and the second TPMI index is one of TPMI index 0-5 in Table 6.3.1.5-1 of TS38.211 for single-layer transmission using two antenna ports; or
   in the case of a real maximum rank for the PUSCH of the first scheme determined based on the configured maximum rank being 3 or 4, each of the first TPMI index and the second TPMI index is one of TPMI index 0-5 in Table 6.3.1.5-1 of TS38.211 for single-layer transmission using two antenna ports and TPMI index 0-2 in Table 6.3.1.5-4 of TS38.211 for two-layer transmission using two antenna ports;
in the case that codebookSubset is configured to nonCoherent, ul-FullPowerTransmission is not configured or configured to fullpowerMode2 or configured to fullpower, and
   in the case of a real maximum rank for the PUSCH of the first scheme determined based on the configured maximum rank being 2, each of the first TPMI index and the second TPMI index is one of TPMI index 0-1 in Table 6.3.1.5-1 of TS38.211 for single-layer transmission using two antenna ports; or
   in the case of a real maximum rank for the PUSCH of the first scheme determined based on the configured maximum rank being 3 or 4, each of the first TPMI index and the second TPMI index is one of TPMI index 0-1 in Table 6.3.1.5-1 of TS38.211 for single-layer transmission using two antenna ports and TPMI index 0 in Table 6.3.1.5-4 of TS38.211 for two-layer transmission using two antenna ports; or
in the case that codebookSubset is configured to nonCoherent, ul-FullPowerTransmission is configured to fullpowerModel, and
   in the case of a real maximum rank for the PUSCH of the first scheme determined based on the configured maximum rank being 2, each of the first TPMI index and the second TPMI index is one of TPMI index 0-2 in Table 6.3.1.5-1 of TS38.211 for single-layer transmission using two antenna ports; or
   in the case of a real maximum rank for the PUSCH of the first scheme determined based on the configured maximum rank being 3 or 4, each of the first TPMI index and the second TPMI index is one of TPMI index 0-2 in Table 6.3.1.5-1 of TS38.211 for single-layer transmission using two antenna ports and TPMI index 0 in Table 6.3.1.5-4 of TS38.211 for two-layer transmission using two antenna ports.

Regarding the exemplary bit width of each configuration field, it is as follows:
in the case that codebookSubset is configured to fullyAndPartialAndNonCoherent, ul-FullPowerTransmission is not configured or configured to fullpowerMode2 or configured to fullpower, and
   in the case of a real maximum rank for the PUSCH of the first scheme determined based on the configured maximum rank being 2, a bit width of each configuration field is 3; or
   in the case of a real maximum rank for the PUSCH of the first scheme determined based on the configured maximum rank being 3 or 4, the bit width of each configuration field is 4;
in the case that codebookSubset is configured to nonCoherent, and ul-FullPowerTransmission is not configured or configured to fullpowerMode2 or configured to fullpower,
   in the case of a real maximum rank for the PUSCH of the first scheme determined based on the configured maximum rank being 2, the bit width of each configuration field is 1; or
   in the case of a real maximum rank for the PUSCH of the first scheme determined based on the configured maximum rank being 3 or 4, the bit width of each configuration field is 2; or
in the case that codebookSubset is configured to nonCoherent, and ul-FullPowerTransmission is configured to fullpowerModel, and
   in the case of a real maximum rank for the PUSCH of the first scheme determined based on the configured maximum rank being 2, the bit width of each configuration field is 2; or
   in the case of a real maximum rank for the PUSCH of the first scheme determined based on the configured maximum rank being 3 or 4, the bit width of each configuration field is 2.

In some embodiments of the present application, the maximum SRS resource port number is 4, the number of PUSCH antenna port is 4, the PUSCH is the PUSCH of the first scheme, there is only one configuration field or there are two configuration fields but only one is a valid field for the PUSCH of the first scheme, and the only one configuration field or the valid field indicates a TPMI index and also indicates the number of the first set of layers and the number of the second set of layers of the PUSCH respectively, wherein:
in the case that codebookSubset is configured to fullyAndPartialAndNonCoherent, ul-FullPowerTransmission is not configured or configured to fullpowerMode2 or configured to fullpower, and
   in the case of a real maximum rank for the PUSCH of the first scheme determined based on the configured maximum rank being 2, the TPMI index is one of TPMI index with 0-21 in Table 6.3.1.5-5 of TS38.211 for two-layer transmission using four antenna ports;
   in the case of a real maximum rank for the PUSCH of the first scheme determined based on the configured maximum rank being 3, the TPMI index is one of TPMI index with 0-21 in Table 6.3.1.5-5 of TS38.211 for two-layer transmission using four antenna ports and TPMI index with 0-6 in Table 6.3.1.5-6 of TS38.211 for three-layer transmission using four antenna ports; or
   in the case of a real maximum rank for the PUSCH of the first scheme determined based on the configured maximum rank being 4, the TPMI index is one of TPMI index with 0-21 in Table 6.3.1.5-5 of TS38.211 for two-layer transmission using four antenna ports, TPMI index with 0-6 in Table 6.3.1.5-6 of TS38.211 for three-layer transmission using four antenna ports and TPMI index with 0-4 in Table 6.3.1.5-7 of TS38.211 for four-layer transmission using four antenna ports;
in the case that codebookSubset is configured to partialAndNonCoherent, ul-FullPowerTransmission is not configured or configured to fullpowerMode2 or configured to fullpower, and
   in the case of a real maximum rank for the PUSCH of the first scheme determined based on the configured maximum rank being 2, the TPMI index is one of TPMI index with 0-13 in Table 6.3.1.5-5 of TS38.211 for two-layer transmission using four antenna ports;
   in the case of a real maximum rank for the PUSCH of the first scheme determined based on the configured maximum rank being 3, the TPMI index is one of TPMI index with 0-13 in Table 6.3.1.5-5 of TS38.211 for two-layer transmission using four antenna ports and TPMI index with 0-2 in Table 6.3.1.5-6 of TS38.211 for three-layer transmission using four antenna ports; or
   in the case of a real maximum rank for the PUSCH of the first scheme determined based on the configured maximum rank being 4, the TPMI index is one of TPMI index with 0-13 in Table 6.3.1.5-5 of TS38.211 for two-layer transmission using four antenna ports, TPMI index with 0-2 in Table 6.3.1.5-6 of TS38.211 for three-layer transmission using four antenna ports and TPMI index with 0-2 in Table 6.3.1.5-7 of TS38.211 for four-layer transmission using four antenna ports;
in the case that codebookSubset is configured to partialAndNonCoherent, ul-FullPowerTransmission is configured to fullpowerModel, and
   in the case of a real maximum rank for the PUSCH of the first scheme determined based on the configured maximum rank being 2, the TPMI index is one of TPMI index with 0-13 in Table 6.3.1.5-5 of TS38.211 for two-layer transmission using four antenna ports;
   in the case of a real maximum rank for the PUSCH of the first scheme determined based on the configured maximum rank being 3, the TPMI index is one of TPMI index with 0-13 in Table 6.3.1.5-5 of TS38.211 for two-layer transmission using four antenna ports and TPMI index with 0-2 in Table 6.3.1.5-6 of TS38.211 for three-layer transmission using four antenna ports; or
   in the case of a real maximum rank for the PUSCH of the first scheme determined based on the configured maximum rank being 4, the TPMI index is one of TPMI index with 0-13 in Table 6.3.1.5-5 of TS38.211 for two-layer transmission using four antenna ports, TPMI index with 0-2 in Table 6.3.1.5-6 of TS38.211 for three-layer transmission using four antenna ports and TPMI index with 0-2 in Table 6.3.1.5-7 of TS38.211 for four-layer transmission using four antenna ports;
in the case that codebookSubset is configured to nonCoherent, ul-FullPowerTransmission is not configured or configured to fullpowerMode2 or configured to fullpower, and
   in the case of a real maximum rank for the PUSCH of the first scheme determined based on the configured maximum rank being 2, the TPMI index is one of TPMI index with 0-5 in Table 6.3.1.5-5 of TS38.211 for two-layer transmission using four antenna ports;
   in the case of a real maximum rank for the PUSCH of the first scheme determined based on the configured maximum rank being 3, the TPMI index is one of TPMI index with 0-5 in Table 6.3.1.5-5 of TS38.211 for two-layer transmission using four antenna ports and TPMI index with 0 in Table 6.3.1.5-6 of TS38.211 for three-layer transmission using four antenna ports; or
   in the case of a real maximum rank for the PUSCH of the first scheme determined based on the configured maximum rank being 4, the TPMI index is one of TPMI index with 0-5 in Table 6.3.1.5-5 of TS38.211 for two-layer transmission using four antenna ports, TPMI index with 0 in Table 6.3.1.5-6 of TS38.211 for three-layer transmission using four antenna ports and TPMI index with 0 in Table 6.3.1.5-7 of TS38.211 for four-layer transmission using four antenna ports; or
in the case that codebookSubset is configured to nonCoherent, ul-FullPowerTransmission is configured to fullpowerModel, and
   in the case of a real maximum rank for the PUSCH of the first scheme determined based on the configured maximum rank being 2, the TPMI index is one of TPMI index with 0-6 in Table 6.3.1.5-5 of TS38.211 for two-layer transmission using four antenna ports;
   in the case of a real maximum rank for the PUSCH of the first scheme determined based on the configured maximum rank being 3, the TPMI index is one of TPMI index with 0-6 in Table 6.3.1.5-5 of TS38.211 for two-layer transmission using four antenna ports and TPMI index with 0-1 in Table 6.3.1.5-6 of TS38.211 for three-layer transmission using four antenna ports; or
   in the case of a real maximum rank for the PUSCH of the first scheme determined based on the configured maximum rank being 4, the TPMI index is one of TPMI index with 0-6 in Table 6.3.1.5-5 of TS38.211 for two-layer transmission using four antenna ports, TPMI index with 0-1 in Table 6.3.1.5-6 of TS38.211 for three-layer transmission using four antenna ports and TPMI index with 0 in Table 6.3.1.5-7 of TS38.211 for four-layer transmission using four antenna ports.

Regarding the exemplary bit width of the only one configuration field or the valid field, it is as follows:
in the case that codebookSubset is configured to fullyAndPartialAndNonCoherent, ul-FullPowerTransmission is not configured or configured to fullpowerMode2 or configured to fullpower, and
   in the case of a real maximum rank for the PUSCH of the first scheme determined based on the configured maximum rank being 2, a bit width of the only one configuration field or the valid field is 5;
   in the case of a real maximum rank for the PUSCH of the first scheme determined based on the configured maximum rank being 3, the bit width of the only one configuration field or the valid field is 7; or
   in the case of a real maximum rank for the PUSCH of the first scheme determined based on the configured maximum rank being 4 and not supporting combination of the first set of layers and the second set of layers (1+3) or (3+1), the bit width of the only one configuration field or the valid field is 8, or in the case of the real maximum rank being 4 and supporting combination of the first set of layers and the second set of layers (1+3) or (3+1), the bit width of the only one configuration field or the valid field is 9;
in the case that codebookSubset is configured to partialAndNonCoherent, ul-FullPowerTransmission is not configured or configured to fullpowerMode2 or configured to fullpower, and
   in the case of a real maximum rank for the PUSCH of the first scheme determined based on the configured maximum rank being 2, the bit width of the only one configuration field or the valid field is 4;
   in the case of a real maximum rank for the PUSCH of the first scheme determined based on the configured maximum rank being 3, the bit width of the only one configuration field or the valid field is 7; or
   in the case of a real maximum rank for the PUSCH of the first scheme determined based on the configured maximum rank being 4 and not supporting combination of the first set of layers and the second set of layers (1+3) or (3+1), the bit width of the only one configuration field or the valid field is 7, or in the case of the real maximum rank being 4 and supporting combination of the first set of layers and the second set of layers (1+3) or (3+1), the bit width of the only one configuration field or the valid field is 8;
in the case that codebookSubset is configured to partialAndNonCoherent, ul-FullPowerTransmission is configured to fullpowerModel, and
   in the case of a real maximum rank for the PUSCH of the first scheme determined based on the configured maximum rank being 2, the bit width of the only one configuration field or the valid field is 4;
   in the case of a real maximum rank for the PUSCH of the first scheme determined based on the configured maximum rank being 3, the bit width of the only one configuration field or the valid field is 7; or
   in the case of a real maximum rank for the PUSCH of the first scheme determined based on the configured maximum rank being 4 and not supporting combination of the first set of layers and the second set of layers (1+3) or (3+1), the bit width of the only one configuration field or the valid field is 7, or in the case of the real maximum rank being 4 and supporting combination of the first set of layers and the second set of layers (1+3) or (3+1), the bit width of the only one configuration field or the valid field is 8;
in the case that codebookSubset is configured to nonCoherent, ul-FullPowerTransmission is not configured or configured to fullpowerMode2 or configured to fullpower, and
   in the case of a real maximum rank for the PUSCH of the first scheme determined based on the configured maximum rank being 2, the bit width of the only one configuration field or the valid field is 3;
   in the case of a real maximum rank for the PUSCH of the first scheme determined based on the configured maximum rank being 3, the bit width of the only one configuration field or the valid field is 5;
   in the case of a real maximum rank for the PUSCH of the first scheme determined based on the configured maximum rank being 4 and not supporting combination of the first set of layers and the second set of layers (1+3) or (3+1), the bit width of the only one configuration field or the valid field is 5, or in the case of a real maximum rank for the PUSCH of the first scheme determined based on the configured maximum rank being 4 and supporting combination of the first set of layers and the second set of layers (1+3) or (3+1), the bit width of the only one configuration field or the valid field is 6; or
in the case that codebookSubset is configured to nonCoherent, ul-FullPowerTransmission is configured to fullpowerModel, and
   in the case of a real maximum rank for the PUSCH of the first scheme determined based on the configured maximum rank being 2, the bit width of the only one configuration field or the valid field is 3;
   in the case of a real maximum rank for the PUSCH of the first scheme determined based on the configured maximum rank being 3, the bit width of the only one configuration field or the valid field is 6; or
   in the case of a real maximum rank for the PUSCH of the first scheme determined based on the configured maximum rank being 4 and not supporting combination of the first set of layers and the second set of layers (1+3) or (3+1), the bit width of the only one configuration field or the valid field is 6, or in the case of the real maximum rank being 4 and supporting combination of the first set of layers and the second set of layers (1+3) or (3+1), the bit width of the only one configuration field or the valid field is 7.

In some embodiments of the present application, the maximum SRS resource port number is 4, the number of PUSCH antenna port is 4, the PUSCH is the PUSCH of the first scheme, and there are two configuration fields, a first field of the two configuration fields indicates the number of the first set of layers and a first TPMI index for the first set of layers and a second field of the two configuration fields indicates the number of the second set of layers and a second TPMI index for the second set of layers, wherein:
in the case that codebookSubset is configured to fullyAndPartialAndNonCoherent, ul-FullPowerTransmission is not configured or configured to fullpowerMode2 or configured to fullpower, and
   in the case of a real maximum rank for the PUSCH of the first scheme determined based on the configured maximum rank being 2, each of the first TPMI index and the second TPMI index is one of TPMI index with 0-27 in Table 6.3.1.5-3 of TS38.211 for single-layer transmission using four antenna ports;
   in the case of a real maximum rank for the PUSCH of the first scheme determined based on the configured maximum rank being 3 or 4 not supporting f combination of the first set of layers and the second set of layers (1+3) or (3+1), each of the first TPMI index and the second TPMI index is one of TPMI index with 0-27 in Table 6.3.1.5-3 of TS38.211 for single-layer transmission using four antenna ports and TPMI index with 0-21 in Table 6.3.1.5-5 of TS38.211 for two-layer transmission using four antenna ports; or
   in the case of a real maximum rank for the PUSCH of the first scheme determined based on the configured maximum rank being 4 supporting f combination of the first set of layers and the second set of layers (1+3) or (3+1), each of the first TPMI index and the second TPMI index is one of TPMI index with 0-27 in Table 6.3.1.5-3 of TS38.211 for single-layer transmission using four antenna ports, TPMI index with 0-21 in Table 6.3.1.5-5 of TS38.211 for two-layer transmission using four antenna ports and TPMI index with 0-6 in Table 6.3.1.5-6 of TS38.211 for three-layer transmission using four antenna ports;
in the case that codebookSubset is configured to partialAndNonCoherent, ul-FullPowerTransmission is not configured or configured to fullpowerMode2 or configured to fullpower, and
   in the case of a real maximum rank for the PUSCH of the first scheme determined based on the configured maximum rank being 2, each of the first TPMI index and the second TPMI index is one of TPMI index with 0-11 in Table 6.3.1.5-3 of TS38.211 for single-layer transmission using four antenna ports;
   in the case of a real maximum rank for the PUSCH of the first scheme determined based on the configured maximum rank being 3 or 4 not supporting combination of the first set of layers and the second set of layers (1+3) or (3+1), each of the first TPMI index and the second TPMI index is one of TPMI index with 0-11 in Table 6.3.1.5-3 of TS38.211 for single-layer transmission using four antenna ports and TPMI index with 0-13 in Table 6.3.1.5-5 of TS38.211 for two-layer transmission using four antenna ports;
   in the case of a real maximum rank for the PUSCH of the first scheme determined based on the configured maximum rank being 4 supporting combination of the first set of layers and the second set of layers (1+3) or (3+1), each of the first TPMI index and the second TPMI index is one of TPMI index with 0-11 in Table 6.3.1.5-3 of TS38.211 for single-layer transmission using four antenna ports, TPMI index with 0-13 in Table 6.3.1.5-5 of TS38.211 for two-layer transmission using four antenna ports and TPMI index with 0-2 in Table 6.3.1.5-6 of TS38.211 for three-layer transmission using four antenna ports;
in the case that codebookSubset is configured to partialAndNonCoherent, ul-FullPowerTransmission is configured to fullpowerModel, and
   in the case of a real maximum rank for the PUSCH of the first scheme determined based on the configured maximum rank being 2, each of the first TPMI index and the second TPMI index is one of TPMI index with 0-15 in Table 6.3.1.5-3 of TS38.211 for single-layer transmission using four antenna ports codebookSubset is configured to partialAndNonCoherent;
   in the case of a real maximum rank for the PUSCH of the first scheme determined based on the configured maximum rank being 3 or 4 not supporting combination of the first set of layers and the second set of layers (1+3) or (3+1), each of the first TPMI index and the second TPMI index is one of TPMI index with 0-15 in Table 6.3.1.5-3 of TS38.211 for single-layer transmission using four antenna ports and TPMI index with 0-13 in Table 6.3.1.5-5 of TS38.211 for two-layer transmission using four antenna ports; or
   in the case of a real maximum rank for the PUSCH of the first scheme determined based on the configured maximum rank being 4 supporting combination of the first set of layers and the second set of layers (1+3) or (3+1), each of the first TPMI index and the second TPMI index is one of TPMI index with 0-15 in Table 6.3.1.5-3 of TS38.211 for single-layer transmission using four antenna ports, TPMI index with 0-13 in Table 6.3.1.5-5 of TS38.211 for two-layer transmission using four antenna ports and TPMI index with 0-2 in Table 6.3.1.5-6 of TS38.211 for three-layer transmission using four antenna ports;
in the case that codebookSubset is configured to nonCoherent, ul-FullPowerTransmission is not configured or configured to fullpowerMode2 or configured to fullpower, and
   in the case of a real maximum rank for the PUSCH of the first scheme determined based on the configured maximum rank being 2, each of the first TPMI index and the second TPMI index is one of TPMI index with 0-3 in Table 6.3.1.5-3 of TS38.211 for single-layer transmission using four antenna ports;
   in the case of a real maximum rank for the PUSCH of the first scheme determined based on the configured maximum rank being 3 or 4 not supporting combination of the first set of layers and the second set of layers (1+3) or (3+1), each of the first TPMI index and the second TPMI index is one of TPMI index with 0-3 in Table 6.3.1.5-3 of TS38.211 for single-layer transmission using four antenna ports and TPMI index with 0-5 in Table 6.3.1.5-5 of TS38.211 for two-layer transmission using four antenna ports; or
   in the case of a real maximum rank for the PUSCH of the first scheme determined based on the configured maximum rank being 4 supporting combination of the first set of layers and the second set of layers (1+3) or (3+1), each of the first TPMI index and the second TPMI index is one of TPMI index with 0-3 in Table 6.3.1.5-3 of TS38.211 for single-layer transmission using four antenna ports, TPMI index with 0-5 in Table 6.3.1.5-5 of TS38.211 for two-layer transmission using four antenna ports and TPMI index with 0 in Table 6.3.1.5-6 of TS38.211 for three-layer transmission using four antenna ports; or
in the case that codebookSubset is configured to nonCoherent, ul-FullPowerTransmission is configured to fullpowerModel, and
   in the case of a real maximum rank for the PUSCH of the first scheme determined based on the configured maximum rank being 2, each of the first TPMI index and the second TPMI index is one of TPMI index with 0-3 and 13 in Table 6.3.1.5-3 of TS38.211 for single-layer transmission using four antenna ports, wherein a bit width of each configuration field is 3;
   in the case of a real maximum rank for the PUSCH of the first scheme determined based on the configured maximum rank being 3 or 4 not supporting combination of the first set of layers and the second set of layers (1+3) or (3+1), each of the first TPMI index and the second TPMI index is one of TPMI index with 0-3 and 13 in Table 6.3.1.5-3 of TS38.211 for single-layer transmission using four antenna ports and TPMI index with 0-6 in Table 6.3.1.5-5 of TS38.211 for two-layer transmission using four antenna ports; or
   in the case of a real maximum rank for the PUSCH of the first scheme determined based on the configured maximum rank being 4 supporting combination of the first set of layers and the second set of layers (1+3) or (3+1), each of the first TPMI index and the second TPMI index is one of TPMI index with 0-3 and 13 in Table 6.3.1.5-3 of TS38.211 for single-layer transmission using four antenna ports, TPMI index with 0-6 in Table 6.3.1.5-5 of TS38.211 for two-layer transmission using four antenna ports and TPMI index with 0-1 in Table 6.3.1.5-6 of TS38.211 for three-layer transmission using four antenna ports.

Regarding the exemplary bit width of each configuration field, it is as follows:
in the case that codebookSubset is configured to fullyAndPartialAndNonCoherent, ul-FullPowerTransmission is not configured or configured to fullpowerMode2 or configured to fullpower, and
   in the case of a real maximum rank for the PUSCH of the first scheme determined based on the configured maximum rank being 2, a bit width of each configuration field is 5;
   in the case of a real maximum rank for the PUSCH of the first scheme determined based on the configured maximum rank being 3 or 4 not supporting combination of the first set of layers and the second set of layers (1+3) or (3+1), the bit width of each configuration field is 6; or
   in the case of a real maximum rank for the PUSCH of the first scheme determined based on the configured maximum rank being 4 supporting combination of the first set of layers and the second set of layers (1+3) or (3+1), the bit width of each configuration field is 6;
in the case that codebookSubset is configured to partialAndNonCoherent, ul-FullPowerTransmission is not configured or configured to fullpowerMode2 or configured to fullpower, and
   in the case of a real maximum rank for the PUSCH of the first scheme determined based on the configured maximum rank being 2, the bit width of each configuration field is 4;
   in the case of a real maximum rank for the PUSCH of the first scheme determined based on the configured maximum rank being 3 or 4 not supporting combination of the first set of layers and the second set of layers (1+3) or (3+1), the bit width of each configuration field is 5; or
   in the case of a real maximum rank for the PUSCH of the first scheme determined based on the configured maximum rank being 4 supporting combination of the first set of layers and the second set of layers (1+3) or (3+1), the bit width of each configuration field is 5; or
in the case that codebookSubset is configured to partialAndNonCoherent, ul-FullPowerTransmission is configured to fullpowerModel, and
   in the case of a real maximum rank for the PUSCH of the first scheme determined based on the configured maximum rank being 2, the bit width of each configuration field is 4;
   in the case of a real maximum rank for the PUSCH of the first scheme determined based on the configured maximum rank being 3 or 4 not supporting combination of the first set of layers and the second set of layers (1+3) or (3+1), the bit width of each configuration field is 5; or
   in the case of a real maximum rank for the PUSCH of the first scheme determined based on the configured maximum rank being 4 supporting combination of the first set of layers and the second set of layers (1+3) or (3+1), the bit width of each configuration field is 6; or
in the case that codebookSubset is configured to nonCoherent, ul-FullPowerTransmission is not configured or configured to fullpowerMode2 or configured to fullpower, and
   in the case of a real maximum rank for the PUSCH of the first scheme determined based on the configured maximum rank being 2, the bit width of each configuration field is 2;
   in the case of a real maximum rank for the PUSCH of the first scheme determined based on the configured maximum rank being 3 or 4 not supporting combination of the first set of layers and the second set of layers (1+3) or (3+1), the bit width of each configuration field is 4; or
   in the case of a real maximum rank for the PUSCH of the first scheme determined based on the configured maximum rank being 4 supporting combination of the first set of layers and the second set of layers (1+3) or (3+1), the bit width of each configuration field is 4; or
in the case that codebookSubset is configured to nonCoherent, ul-FullPowerTransmission is configured to fullpowerModel, and
   in the case of a real maximum rank for the PUSCH of the first scheme determined based on the configured maximum rank being 2, the bit width of each configuration field is 3;
   in the case of a real maximum rank for the PUSCH of the first scheme determined based on the configured maximum rank being 3 or 4 supporting combination of the first set of layers and the second set of layers (1+3) or (3+1), the bit width of each configuration field is 4; or
   in the case of a real maximum rank for the PUSCH of the first scheme determined based on the configured maximum rank being 4 supporting combination of the first set of layers and the second set of layers (1+3) or (3+1), the bit width of each configuration field is 4.

In some embodiments of the present application, in the case that there is only one configuration field or there are two configuration fields but only one is valid for the PUSCH with the first scheme, a bit width of the only one configuration field or the valid field is a maximum of a bit width expected for the PUSCH of the first scheme and a bit width expected for the PUSCH of a scheme different from the first scheme that is always associated with one SRS resource set of the two SRS resource sets.

In some embodiments of the present application, in the case that there are two configuration fields, a bit width of a first field of the two configuration fields is a maximum of a bit width expected for the PUSCH of the first scheme and a bit width expected for the PUSCH of a scheme different from the first scheme that is always associated with one SRS resource set of the two SRS resource sets, and a bit width of a second field of the two configuration fields is a bit width expected for the PUSCH of the first scheme.

In some embodiments of the present application, in the case that there are two configuration fields, a bit width of a first field of the two configuration fields is a maximum of a bit width expected for the PUSCH of the first scheme and a bit width expected for the PUSCH of a scheme different from first scheme that is always associated with one SRS resource set of the two SRS resource sets, and a bit width of a second field of the two configuration fields is a bit width expected for the PUSCH of a scheme different from the first scheme that is indicated as a repetition Type A or B PUSCH with repetition number larger than 1 and is indicated to be associated with the two SRS resource sets.

In some embodiments of the present application, in the case that there are two configuration fields, a bit width of a first field of the two configuration fields is a maximum of a bit width expected for the PUSCH of the first scheme and a bit width expected for the PUSCH in a scheme different from the first scheme that is always associated with one SRS resource set of the two SRS resource sets, and a bit width of a second field of the two configuration fields is a maximum of a bit width expected for the PUSCH of scheme different from the first scheme that is indicated as a repetition Type A or B PUSCH with repetition number larger than 1 and is indicated to be associated with the two SRS resource sets and a bit width expected for the PUSCH of the first scheme.

In some embodiments of the present application, in the case that only one maximum rank is configured for PUSCH transmissions, a real maximum rank for determining the precoding information for the PUSCH of the first scheme is the configured maximum rank, and a real maximum rank for determining the precoding information for the PUSCH of a scheme different from the first scheme is a smaller one between the maximum SRS resource port number and the configured maximum rank of the first scheme.

In some embodiments of the present application, in the case that two maximum ranks are respectively configured for a PUSCH of the first scheme and a PUSCH of a scheme different from the first scheme, a real maximum rank for determining the precoding information for the PUSCH is the configured maximum rank associated with a PUSCH scheme of the PUSCH.

In some embodiments of the present application, in the case that only one maximum rank is configured for PUSCH transmissions, a real maximum rank for determining the precoding information for the PUSCH of the first scheme is a smaller one between a predefined maximum rank for the PUSCH of the first scheme and a double of the configured maximum rank, and a real maximum rank for determining the precoding information for the PUSCH of a scheme different from the first scheme is the configured maximum rank.

In some scenarios, e.g., scenarios that the maximum SRS resource port number and the number of PUSCH antenna port are 2, the configured maximum rank is 2, or scenarios that the maximum SRS resource port number is 4, the number of PUSCH antenna port is 4, for the PUSCH of the first scheme, one PUSCH antenna port is associated with a SRS port of two associated SRS resources of the PUSCH of the two SRS resource sets.

In view of the above, embodiments of the present application provide a technical solution of uplink transmission, which discloses: a) available precoding matrixes for NCJT PUSCH considering various scenarios, e.g., different TPMI indication methods, different SRS port numbers, different maxRank configurations and different codebook subset configurations etc.; b) the mapping of NCJT PUSCH antenna ports and SRS ports of associated SRS resources under different configurations; and c) bit width determination of field(s) of indicating precoding information and layer number considering the dynamic switching between NCJT PUSCH and other PUSCH schemes, e.g., S-TRP PUSCH and M-TRP PUSCH repetition. Accordingly, embodiments of the present application will facilitate the implementation of NCJT PUSCH in NR, even if in scenarios that dynamic switching between or among NCJT PUSCH and other PUSCH scheme(s) are supported.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to an embodiment of the present application.

FIG. 2 illustrates a flow chart of a method of uplink transmission according to some embodiments of the present application.

FIG. 3 illustrates a block diagram of an apparatus of uplink transmission according to some embodiments of the present application.

FIG. 4 illustrates a block diagram of an apparatus of uplink transmission according to some other embodiments of the present application.

### DETAILED DESCRIPTION

The detailed description of the appended drawings is intended as a description of preferred embodiments of the present application, and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G, 3GPP long term evolution (LTE) Release 8 and so on. It is contemplated that along with the developments of network architectures and new service scenarios, all embodiments in the present application are also applicable to similar technical problems. Moreover, the terminologies recited in the present application may change, which should not affect the principle of the present application.

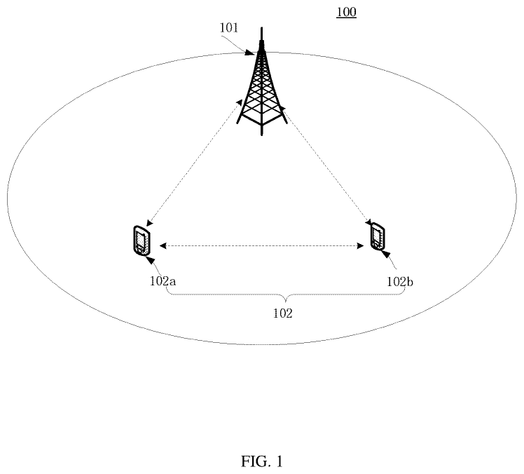

FIG. 1 illustrates a schematic diagram of an exemplary wireless communication system 100 according to some embodiments of the present application.

As shown in FIG. 1, the wireless communication system 100 includes at least one BS 101 and at least one UE 102. In particular, the wireless communication system 100 includes one BS 101 and two UE 102 (e.g., a UE 102a and UE 102b) for illustrative purpose. Although a specific number of BSs and UEs are illustrated in FIG. 1 for simplicity, it is contemplated that the wireless communication system 100 may include more or less BSs and UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may communicate with a core network (CN) node (not shown), e.g., a mobility management entity (MME) or a serving gateway (S-GW), a mobility management function (AMF) or a user plane function (UPF) etc. via an interface. A BS also be referred to as an access point, an access terminal, a base, a macro cell, a node-B, an enhanced node B (eNB), a gNB, a home node-B, a relay node, or a device, or described using other terminology used in the art. In 5G NR, a BS may also refer to as a radio access network (RAN) node. Each BS may serve a number of UE(s) within a serving area, for example, a cell or a cell sector via a wireless communication link. Neighbor BSs may communicate with each other as necessary, e.g., during a handover procedure for a UE.

In addition, a BS 101 may be configured with one TRP (or panel), i.e., in a single-TRP scenario or more TRPs (or panels), i.e., a multi-TRP scenario. That is, one or more TRPs are associated with the BS 101. A TRP can act like a small BS. A single TRP can be used to serve one or more UE 103 under the control of a BS 101. In different scenarios, a TRP may be referred to as different terms, which may be represented by a TCI state index or CORESETPoolIndex value etc. It should be understood that the TRP(s) (or panel(s)) configured for the BS 101 may be transparent to a UE 102. Two TRPs can have the same cell ID (identity or index) or different cell IDs. Two TRPs can communicate with each other by a backhaul link. Such a backhaul link may be an ideal backhaul link or a non-ideal backhaul link. Latency of the ideal backhaul link may be deemed as zero, and latency of the non-ideal backhaul link may be tens of milliseconds and much larger, e.g. on the order of tens of milliseconds, than that of the ideal backhaul link.

The UE 102, e.g., the UE 102a and UE 102b may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE may include wearable devices, such as smart watches, fitness bands, optical head-mounted displays, or the like. Moreover, the UE may be referred to as a subscriber unit, a mobile, a mobile station, a user, a terminal, a mobile terminal, a wireless terminal, a fixed terminal, a subscriber station, a user terminal, or a device, or described using other terminology used in the art.

Similar to NCJT PDSCH introduced in Rel-16, it is expected that NCJT PUSCH will be supported in Rel-18, which is a kind of multi-panel simultaneous UL transmission, e.g., two panels being used for simultaneous UL transmission. Herein, NCJT PUSCH can be referred to a PUSCH scheme where a first set of layers of the PUSCH is associated with a first SRS resource set of the two SRS resource sets and a second set of layers of the PUSCH which are remaining layers except for the first set of layers of the PUSCH is associated with a second SRS resource set of the two SRS resource sets, and both a number of the first set of layers and a number of the second set of layers are equal to or larger than 1. Since there are some differences between PDSCH and PUSCH, how to transmit NCJT PUSCH should be further studied and cannot directly use the same solutions for NCJT PDSCH.

For example, one big difference between PDSCH and PUSCH transmission is: only DMRS ports are indicated for a PDSCH transmission while both precoding information, e.g. precoding matrix and DMRS ports must be indicated for codebook based PUSCH transmission. Thus, how to determine precoding information for NCJT PUSCH transmission should be studied and solved.

Besides, according to clause 6.1.2.3 in TS 38.214, the UE shall transmit PUSCH using the same antenna port(s) as the SRS port(s) in the SRS resource indicated by the DCI format 0_1 or 02 or by configuredGrantConfig in radio resource control (RRC) signaling. That is, the PUSCH antenna ports of codebook based PUSCH transmission is the same as the SRS ports of associated SRS resource of the PUSCH. A codebook based NCJT PUSCH transmission will be associated with two SRS resources within two different SRS resource sets, in the case that two panels are used for a NCJT PUSCH and two SRS resource sets are configured for the NCJT PUSCH. Therefore, how to determine the association between PUSCH antenna ports and SRS ports in two associated SRS resources within two SRS resource sets for a NCJT PUSCH transmission should also be solved, which will impact the determination of precoding information for NCJT PUSCH transmission.

Furthermore, it is possible to support dynamic switching between or among NCJT PUSCH and other PUSCH scheme(s), e.g., S-TRP PUSCH and M-TRP PUSCH repetition in the future. How to determine the configuration for a PUSCH, e.g., the bit width of “precoding information and number of layers” field should also be solved considering the PUSCH scheme dynamic switching, which will also impact the determination of precoding information of NCJT PUSCH transmission. Herein, S-TRP PUSCH can be referred to a PUSCH scheme that is always associated with one SRS resource set of the two SRS resource sets, and M-TRP PUSCH repetition can be referred to a PUSCH scheme that is indicated as a repetition Type A or B PUSCH with repetition number larger than 1 and is indicated to be associated with two SRS resource sets.

At least to solve the above technical problems, embodiments of the present application propose a technical solution of uplink transmission, which specifies the association between PUSCH antenna port and SRS ports for NCJT PUSCH, and can correctly determine the precoding information for NCJT PUSCH, especially in the scenarios of supporting dynamic switch between or among NCJT PUSCH and one or more other PUSCH schemes. Herein, other PUSCH scheme(s) or non-NCJT PUSCH refers to S-TRP PUSCH and M-TRP PUSCH repetition. However, embodiments of the present application do not exclude other PUSCH schemes in the future that can be adapted to the disclosed solutions.

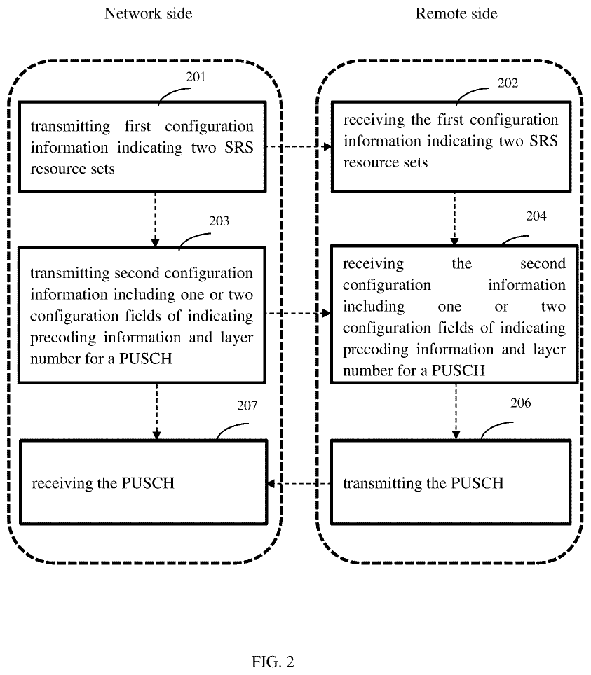

FIG. 2 illustrates a flow chart of a method of uplink transmission according to some embodiments of the present application. Although the method is illustrated in a system level by a UE in a remote side (or UE side) and a RAN node, e.g., a gNB in a network side (or BS side), persons skilled in the art can understand that the method implemented in the remote side and that implemented in the network side can be separately implemented and incorporated by other apparatus with similar functions. In addition, no transmission or reception failure is considered in the illustrated embodiments of the present application.

Referring to FIG. 2, the network side, e.g., a gNB may transmit first configuration information to the UE, indicating two SRS resource sets for PUSCH transmissions in step 201. Accordingly, the UE will receive the first configuration information in step 202.

For example, two SRS resource sets with usage set as ‘codebook’ or ‘non-codebook’ are configured for PUSCH transmission, wherein each SRS resource set is associated with one UE panel (or one TRP in the network side). The first SRS resource set is the SRS resource with a lower index of the two SRS resource sets, and the second SRS resource set is a SRS resource set with a higher index of the two SRS resource sets. For NCJT codebook based PUSCH transmission (NCJT PUSCH), two SRS resource sets with usage set as “codebook” will be configured. If more than one SRS resource is configured for each SRS resource set, two SRS resources from the two SRS resource sets will be indicated by two SRS resource indicator (SRI) fields to be associated with the NCJT PUSCH; or if only one SRS resource is configured for each SRS resource set, two SRS resources within the two SRS resource sets will be associated with the NCJT PUSCH.

Besides, only symmetrical panels are considered in the illustrated embodiments, which means that the UL transmission capability of each panel is identical, the SRS resource number of each SRS resource set is identical, and the maximum SRS resource port number of each SRS resource set is identical. According to the legacy specification, only when ul-FullPowerTransmission is configured to fullpowerMode2, the SRS port number of each SRS resource in a SRS resource set can be different; otherwise, the SRS port number of each SRS resource in a SRS resource set will always be identical.

In step 203, the network side will transmit second configuration information including one or two configuration fields of indicating precoding information and layer number for a PUSCH, e.g., transmitting DCI or RRC signaling includes one or two precoding information and layer number fields. Accordingly, the UE will receive the second configuration information in step 204. Regarding the PUSCH, it can be in various schemes considering dynamic switch between or among NCJT PUSCH and other PUSCH schemes. For example, the PUSCH can be a NCJT PUSCH or a non-NCJT PUSCH (e.g., S-TRP PUSCH or M-TRP PUSCH repetition). Whether a PUSCH transmission is a NCJT PUSCH transmission or not can be determined by an SRS resource set indicator or a beam indicator in the corresponding DCI or RRC configuration of the PUSCH with or without a corresponding RRC parameter.

In step 206, the UE will transmit the PUSCH with precoding information determined at least according to the one or two configuration fields, the maximum SRS resource port number of the two SRS resource sets, the number of PUSCH antenna port (the number of antenna port for PUSCH), the configured maximum rank for the PUSCH, and whether the PUSCH is a NCJT PUSCH or a non-NCJT PUSCH. Accordingly, the network side will receive the PUSCH in step 207. As stated above, the maximum SRS resource port number of the two SRS resource sets is the SRS resource port number of the two SRS resource sets except for that ul-FullPowerTransmission is configured to fullpowerMode2. In the following, for simplification and clearness, the SRS resource port number also means the maximum SRS resource port number in the case that ul-FullPowerTransmission is configured to fullpowerMode2.

Since precoding information on S-TRP PUSCH and M-TRP PUSCH repetition has been settled, it will not be repeated herein. Regarding the precoding information of NCJT PUSCH, although it has been discussed a lot, all these discussions are in high level to describe the precoding indication for NCJT PUSCH transmission. How to interpret the field of indicating precoding information and layer number (e.g., determine the bit width of the field and information indicated by the fields etc.) has not been discussed yet, which is related to the maximum rank (e.g., maxRank) configured for PUSCH, PUSCH antenna port number (or SRS port number of SRS resources configured for PUSCH), PUSCH waveform, codebook subset configuration (e.g., codebookSubset) and full power configuration (e.g., ul-FullPowerTransmission) etc.

For example, the value of maxRank should not be larger than SRS port number in S-TRP PUSCH transmission or M-TRP PUSCH repetition transmission.

However, if NCJT PUSCH transmission can be supported with two antenna ports wherein one SRS resource port per panel is configured for PUSCH transmission or can be supported with four antenna ports wherein two SRS resource ports per panel is configured for PUSCH transmission, the maxRank can be configured to be larger than SRS port number. Besides, the PUSCH antenna port number in these cases will be double of the SRS port number in some scenarios. Therefore, the interpretation of the field of indicating precoding information and layer number for NCJT PUSCH may be different from S-TRP PUSCH or M-TRP PUSCH repetition.

Considering that, in the case that dynamic switch between or among NCJT PUSCH and non-NCJT PUSCH(s), e.g., S-TRP PUSCH and/or M-TRP PUSCH repetition is supported, how to configure the maxRank for different PUSCH schemes and/or how to determine the real maxRank for determining the precoding information is important to correctly determine the precoding information for different PUSCH schemes.

In some embodiments of the present application, only one maximum rank can be configured for PUSCH transmissions, that is, maxRank for different PUSCH schemes cannot be separately configured. A real maximum rank for determining the precoding information for a NCJT PUSCH is the configured maximum rank, and a real maximum rank for determining the precoding information for a non-NCJT PUSCH is a smaller one between the maximum SRS resource port number and the configured maximum rank of NCJT PUSCH (Solution 1 of maxRank). For example, if the maxRank is configured to be 2, the real maxRank of NCJT PUSCH is the configured maxRank, i.e. 2, while the real maxRank of a non-NCJT PUSCH is 1.

In some other embodiments of the present application, two maximum ranks can be respectively configured for a NCJT PUSCH and a non-NCJT PUSCH. Then, a real maximum rank for determining the precoding information for the NCJT PUSCH or non-NCJT PUSCH is the corresponding configured maximum rank respectively (Solution 2 of maxRank). For example, in the case that the maxRank for NCJT PUSCH and the maxRank for non-NCJT PUSCH can be respectively configured to be 2 and 1, the real maxRank for the NCJT PUSCH is 2 and the real maxRank for the non-NCJT PUSSCH is 1.

In some yet embodiments of the present application, similar to Solution 1 of maxRank, only one maximum rank is configured for PUSCH transmissions. However, a real maximum rank for determining the precoding information for a NCJT PUSCH is a smaller one between a predefined maximum rank, e.g. 4 for the NCJT PUSCH and a double of the configured maximum rank, and a real maximum rank for determining the precoding information for the non-NCJT PUSCH is the configured maximum rank (Solution 3 of maxRank). For example, if the maxRank is configured to be 2, the real maxRank of NCJT PUSCH is min(4, 2*1), i.e. 2 (it is supposed that a predefined maximum rank for the NCJT PUSCH is 4), while the real maxRank of a non-NCJT PUSCH is the configured maxRank for non-NCJT PUSCH, i.e. 1.

It can be seen that, the real maxRank for determining the precoding matrixes for NCJT PUSCH will the same as the configured maxRanks in the case that only NCJT PUSCH is considered; while in the case that dynamic switch between or among different PUSCH schemes is supported, the real maxRank for determining the precoding matrixes for NCJT PUSCH may be different from the configured maxRank. For simplification and clearness, all the maxRanks used for determining precoding information, e.g., precoding matrixes for NCJT PUSCH in the following refer to the real maxRank.

Regarding the waveform, since discrete Fourier transform-spread orthogonal frequency division multiplexing (DFT-s-OFDM) based PUSCH can only support single layer transmission, only cyclic prefix orthogonal frequency division multiplexing (CP-OFDM) based PUSCH can be configured for NCJT PUSCH. Thus, waveform will not be additionally considered for NCJT PUSCH herein.

In addition, according to Rel-18 workshop discussion, no new precoding matrixes will be designed for NCJT PUSCH transmission. Therefore, the precoding matrixes for NCJT PUSCH will only be selected from the legacy precoding matrixes, e.g., TPMIs specified in TS38.211 according to some embodiments of the present application. Specifically, regarding TPMI, TS 38. 214 specifies the following:
“Each TPMI, based on indicated codepoint of SRS Resource Set indicator, is used to indicate the precoder to be applied over the layers {0 . . . v−1} and that corresponds to the SRS resource selected by the corresponding SRI when multiple SRS resources are configured for the applicable SRS resource set, or if a single SRS resource is configured for the applicable SRS resource set TPMI is used to indicate the precoder to be applied over the layers {0 . . . v−1} and that corresponds to the SRS resource. For one or two TPMI(s), the transmission precoder is selected from the uplink codebook that has a number of antenna ports equal to the higher layer parameter nrofSRS-Ports in SRS-Config for the indicated SRI(s), as defined in Clause 6.3.1.5 of [4, TS 38.211]. When two SRIs are indicated, the UE shall expect the nrofSRS-Ports for the two indicated SRS resources to be the same.”

Given the above, more detailed embodiments of the present application will be illustrated in the following in view of various association between SRS ports and PUSCH antenna ports in difference scenarios, wherein dynamic switch between or among NCJT PUSCH and non-NCJT PUSCH(s) are also considered. Persons skilled in the art should well know that although some legacy configuration settings or parameters, e.g. “codebookSubset” and “fullyAndPartialAndNonCoherent” etc. are used to illustrate the embodiments, they may change along the 3GPP evolution and thus should not be used to unduly limit the scope of the present application. The scope of the present application should cover the changes caused by terminology, parameters and interpretation etc. due to 3GPP evolution. In addition, the bit width of each field illustrated in some embodiments of the present application is the exemplary needed (or maximal bit width considering overhead. Smaller bit width can be also designed in other embodiments of the present application to reduce the overhead.

### Scenario I: One SRS Port is Configured for Each SRS Resource Set

When there is only one SRS port configured for each SRS resource set, two cases will be discussed in the following. Which case the UE will support can be configured by RRC or predefined in the specification.

### Case 1-1: PUSCH Antenna Port Number is Always 1

In Case 1-1, the PUSCH antenna port is fixed to be 1, and is the same as the SRS port of the associated SRS resource set of the PUSCH. For example, the SRS port of two SRS resource sets is 0, then the antenna port of a PUSCH is SRS port 0 of one associated SRS resource set of the PUSCH or SRS port 0 of two associated SRS resource sets of the PUSCH. If the PUSCH is indicated to be associated with two SRS resource sets, the two SRS ports from the two SRS resource sets will be mapped to the only one PUSCH antenna port.

It can be seen that NCJT PUSCH cannot be supported in Case 1-1, but S-TRP PUSCH and M-TRP PUSCH repetition can be supported. Since only one single layer can be supported, the field of indicating precoding information and layer number, e.g., “precoding information and number of layers” field is 0 bit according to the legacy specification.

### Case 1-2: PUSCH Antenna Port Number is 1 or 2

In Case 1-2, NCJT PUSCH can be supported, and the PUSCH antenna port number is 2.

In the case that the PUSCH is a NCJT PUSCH, then the first PUSCH antenna port is the SRS port of the first indicated SRS resource (indicated by the first SRI) associated with the PUSCH, and the second PUSCH antenna port is the SRS port of the second indicated SRS resource (indicated by the second SRI) associated with the PUSCH. For example, the SRS port of the two SRS resource sets is 0, and then antenna ports 0 and 1 of a NCJT PUSCH are respectively SRS port 0 of the first and second associated SRS resources of the PUSCH from the two SRS resource sets.

In the case that the PUSCH is a non-NCJT PUSCH, e.g., an S-TRP PUSCH or an M-TRP PUSCH repetition, then the PUSCH antenna port number is 1. For example, if the PUSCH is indicated to be associated with one SRS resource set, antenna port 0 of the PUSCH is SRS port 0 of the associated SRS set; or if the PUSCH is indicated to be associated with two SRS resource sets, antenna port 0 of the PUSCH is SRS port 0 of the two associated SRS resource sets. If the PUSCH is indicated to be associated with two SRS resource sets simultaneously, the two SRS ports from the two SRS resource sets will be mapped to the only one PUSCH antenna port.

In view of legacy specification, the precoder (precoding information or precoding matrix) of a NCJT PUSCH is TPMI 0 for two-layer transmission using two antenna ports, which is

$$\frac{1}{\sqrt{2}} [ \begin{matrix}1 & 0 \\ 0 & 1\end{matrix} ]$$

in Table 6.3.1.5-4 of TS38.211. Since only one precoder is used for NCJT PUSCH, there is no need to indicate the precoder in the field of indicating precoding information and layer number with bit to save overhead. Accordingly, 0 bit is determined for the field of indicating precoding information and layer number for NCJT PUSCH where the bit width of the field of indicating precoding information and layer number is unchanged compared with S-TRP PUSCH or M-TRP PUSCH repetition. Therefore, the bit width of the field of indicating precoding information and layer number when one SRS port will always be configured to be 0 according to some embodiments of the present application.

Besides, regarding the maxRank configuration, for NCJT PUSCH in Case 2-1, the maxRank will be configured to be 2 due to the antenna port number being 2. When dynamic switch between NCJT PUSCH and non-NCJT PUSCH is supported, according to Solution 1 of maxRank, the maxRank will be configured to be 2, wherein the maxRank of NCJT PUSCH is 2 but the real maxRank of non-NCJT PUSCH is 1; according to Solution 2 of maxRank, the maxRank for NCJT PUSCH will be configured as 2 and the maxRank for non-NCJT PUSCH is 1; and according to Solution 3 of maxRank, the maxRank of PUSCH schemes except for NCJT PUSCH is 1 and the real maxRank of NCJT PUSCH is 2.

Since the layer in Case 1-2 is indicated by the PUSCH schemes, information, e.g., the DMRS ports for PUSCH indicated in the field “Antenna ports” will be determined according to the PUSCH schemes. If a PUSCH is indicated as a NCJT PUSCH, the DMRS ports for PUSCH indicated in the field “Antenna ports” is determined based on rank being 2. If a PUSCH is indicated as a non-NCJT PUSCH, the DMRS ports for PUSCH indicated in the field “Antenna ports” is determined based on rank being 1.

### Scenario II: Two SRS Ports are Configured for Each SRS Resource Set

Similarly, two cases will be discussed in the following. Which case the UE will support can be configured by RRC or predefined in the specification.

### Case 2-1: The PUSCH Antenna Port Number is Always 2

In Case 2-1, two PUSCH antenna ports, e.g. antenna ports 0 and 1 of a PUSCH are the two SRS ports of one associated SRS resource of the PUSCH if the PUSCH is indicated to be associated with one SRS resource set, or are two SRS ports of two associated SRS resources of the PUSCH if the PUSCH is indicated to be associated with two SRS resource sets simultaneously. For example, if the PUSCH is indicated to be associated with two SRS resource sets simultaneously, SRS ports 0 and 1 of a SRS resource within the first SRS resource set and SRS ports 0 and 1 of another SRS resource within the second SRS resource set will be mapped to antenna ports 0 and 1 respectively.

For NCJT PUSCH in Case 2-1, the maxRank will be configured to be 2 due to the antenna port number being 2. When dynamic switch between NCJT PUSCH and non-NCJT PUSCH is supported, according to Solution 1 of maxRank, the maxRank will be configured to be 2, wherein the maxRank of NCJT PUSCH is 2 but the real maxRank of non-NCJT PUSCH is 2; and according to Solution 2 of maxRank, the maxRank for NCJT PUSCH will be configured as 2 and the maxRank for non-NCJT PUSCH can be 1 or 2.

Regarding the field of indicating precoding information and layer number, it can be one or two. Accordingly, different schemes will be illustrated in view of one or two fields of indicating precoding information and layer number.

Scheme 2-1-1: One field of indicating precoding information and layer number or two fields of indicating precoding information and layer number but only one being valid for NCJT PUSCH

According to some embodiments of the present application, the one field of indicating precoding information and layer number can be an enhanced “precoding information and number of layers” field compared with the legacy “precoding information and number of layers” field. The enhanced “precoding information and number of layers” field includes one rank combination indication and a legacy “precoding information and number of layers” indication (information indicated in legacy “precoding information and number of layers” field). The rank combination indication indicates how many layers are associated with the first and second indicated SRS resource sets respectively, and can also referred to layer combination or layer number combination. Since only maxRank being 2 can be configured for NCJT PUSCH in Scenario II, there is only one rank combination, i.e., (1+1), that is, both the first set of layers and second set of layers only include one layer, and both the number of the first set of layers (how many layers in the first set of layers) and the number of the second set of layers (how many layers in the second set of layers) are 1. Therefore, only “precoding information and number of layers” information will be indicated, which will indicate the whole precoding matrix on two panels. Considering two layers will be transmitted in a NCJT PUSCH, there is only one such whole precoding matrix.

Specifically, the precoding matrix for the NCJT PUSCH can be formulated as:

$$S = p ( \begin{matrix}x 1 \\ x 2\end{matrix} ) = ( p 1 p 2 ) ( \begin{matrix}x 1 \\ x 2\end{matrix} ) = p 1 x 1 + p 2 x 2$$

Wherein, x1, x2 are two sets of layers (or two layers in Case 2-1), p is a 2×2 matrix, p1 and p2 are 2×1 vectors. p1 will be applied over the first set of layers x1 and correspond to the first indicated SRS resource by the first SRI field if it is present, and p2 will be applied over the second set of layers x2 and corresponds to the second indicated SRS resource by the second SRI field if it is present. The field of enhanced precoding information and layer number will indicate p and the combination of the number of the first and second set of layers for NCJT PUSCH transmission.

The precoding matrix in Table 6.3.1.5-4 of TS38.211 (reproduced below) for two-layer transmission using two antenna ports can be selected for NCJT PUSCH.

TABLE 6.3.1.5-4
Precoding matrix W for two-layer transmission using
two antenna ports with transform precoding disabled.

| TPMI | W | | |
|---|---|---|---|
| index | (ordered from left to right in increasing order of TPMI index) | | |
| 0-2 | $\frac{1}{\sqrt{2}} [ \begin{matrix}1 & 0 \\ 0 & 1\end{matrix} ]$ | $\frac{1}{2} [ \begin{matrix}1 & 1 \\ 1 & - 1\end{matrix} ]$ | $\frac{1}{2} [ \begin{matrix}1 & 1 \\ j & - j\end{matrix} ]$ |

According to legacy specification, when two SRS ports are configured for each SRS resource set, codebookSubset can be configured as fullyAndPartialAndNonCoherent or noncoherent; and only if codebookSubset is configured to nonCoherent, ul-FullPowerTransmission can be configured to fullpowerModel. Thus, different configurations of codebookSubset will affect the determination of precoding matrix.

Specifically, if codebookSubset is configured to fullyAndPartialAndNonCoherent, and ul-FullPowerTransmission is not configured or configured to fullpowerMode2 or configured to fullpower, then the available precoding matrixes for NCJT PUSCH are TPMI index with 0-2 in Table 6.3.1.5-4 for two-layer transmission using two antenna ports. The TPMI indicated in the field for NCJT PUSCH is one of the available precoding matrixes. The bit width of field of indicating precoding information and layer number is 2, regardless of whether it is a legacy “Precoding information and layer number” field or an enhanced “Precoding information and layer number” field.

If codebookSubset is configured to nonCoherent, and ul-FullPowerTransmission is not configured or configured to fullpowerMode2 or configured to fullpower, the available precoding matrix for NCJT PUSCH is TPMI index with 0 in Table 6.3.1.5-4 for two-layer transmission using two antenna ports. The TPMI indicated in the field for NCJT PUSCH is the only one available precoding matrix. The bit width of field of indicating precoding information and layer number is 0, regardless of whether it is a legacy “Precoding information and layer number” field or an enhanced “Precoding information and layer number” field.

If codebookSubset is configured to nonCoherent, and ul-FullPowerTransmission is configured to fullpowerModel, the available precoding matrix for NCJT PUSCH is TPMI index with 0 in Table 6.3.1.5-4 for two-layer transmission using two antenna ports. The TPMI indicated in the field for NCJT PUSCH is the only one available precoding matrix. The bit width of field of indicating precoding information and layer number is 0, regardless of whether it is a legacy “Precoding information and layer number” field or an enhanced “Precoding information and layer number” field.

When there are two fields of indicating precoding information and layer number but only one is valid for NCJT PUSCH, details of the one field illustrated above can be applied to the only one valid field, and thus will not be repeated.

### Scheme 2-1-2: Two Valid Fields of Indicating Precoding Information and Layer Number

According to some embodiments of the present application, the two fields of indicating precoding information and layer number can be two legacy “precoding information and number of layers” fields.

Each precoding matrix on each panel indicated by each field of indicating precoding information and layer number will be formulated as:

$$S = p 1 x 1 + p 2 x 2$$

Wherein, p1 and p2 are 2×1 vectors, p1 will be applied over the first set of layers x1 and correspond to the first indicated SRS resource by the first SRI field if it is present, and p2 will be applied over the second set of layers x2 and correspond to the second indicated SRS resource by the second SRI field if it is present. The first field of indicating precoding information and layer number indicates p1 and the number of the first set of layers associated with pl while the second field of indicating precoding information and layer number indicates p2 and the number of the second set of layers associated with p2.

The precoding matrix in Table 6.3.1.5-1 of TS38.211 (reproduced below) for single-layer transmission using two antenna ports can be selected for NCJT PUSCH.

TABLE 6.3.1.5-1
Precoding matrix W for single-layer transmission using two antenna ports.

| TPMI | W | | | | | | | |
|---|---|---|---|---|---|---|---|---|
| index | (ordered from left to right in increasing order of TPMI index) | | | | | | | |
| 0-5 | $\frac{1}{\sqrt{2}} [ \begin{matrix}1 \\ 0\end{matrix} ]$ | $\frac{1}{\sqrt{2}} [ \begin{matrix}0 \\ 1\end{matrix} ]$ | $\frac{1}{\sqrt{2}} [ \begin{matrix}1 \\ 1\end{matrix} ]$ | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ | $\frac{1}{\sqrt{2}} [ \begin{matrix}1 \\ - j\end{matrix} ]$ | — | — |

Specifically, if codebookSubset is configured to fullyAndPartialAndNonCoherent and ul-FullPowerTransmission is not configured or configured to fullpowerMode2 or configured to fullpower, the available precoding matrixes for NCJT PUSCH are TPMI index with 0-5 in Table 6.3.1.5-1 for single-layer transmission using two antenna ports. The TPMI indicated in each of the two fields of indicating precoding information and layer number for NCJT PUSCH is one of the available precoding matrixes. The bit width of each of the two fields of indicating precoding information and layer number is 3 and the total bit width of the two fields will be 6.

If codebookSubset is configured to nonCoherent and ul-FullPowerTransmission is not configured or configured to fullpowerMode2 or configured to fullpower, the available precoding matrixes for NCJT PUSCH are TPMI index with 0-1 in Table 6.3.1.5-1 for single-layer transmission using two antenna ports. The TPMI indicated in each of the two fields of indicating precoding information and layer number for NCJT PUSCH is one of the available precoding matrixes. The bit width of each of the two fields of indicating precoding information and layer number is 1 and the total bit width of the two fields will be 2.

If codebookSubset is configured to nonCoherent and ul-FullPowerTransmission is configured to fullpowerModel, the available first or second precoding matrixes for NCJT PUSCH are TPMI index with 0-2 in Table 6.3.1.5-1 for single-layer transmission using two antenna ports. The TPMI indicated in each of the two fields of indicating precoding information and layer number for NCJT PUSCH is one of the available precoding matrixes. The bit width of each of the first and second field of “precoding information and layer number” will be 2 and the total bit width of the two fields will be 4.

### Case 2-2: The PUSCH Antenna Port Number is 2 or 4.

In Case 2-2, NCJT PUSCH can be supported, and the PUSCH antenna port number is 4.

In the case that the PUSCH is a NCJT PUSCH, two PUSCH antenna ports of the four PUSCH antenna ports are 2 SRS ports of the first indicated SRS resource of the PUSCH (e.g., indicated by the first SRI) respectively, and the other two PUSCH antenna ports are 2 SRS ports of the second indicated SRS resource of the PUSCH (e.g., indicated by the second SRI) respectively.

In the case that the PUSCH is not a NCJT PUSCH, then the PUSCH antenna port number is 2. For example, if the PUSCH is indicated to be associated with one SRS resource set, antenna port 0 and 1 of a non-NCJT PUSCH are SRS port 0 and 1 of one associated SRS resource of the SRS resource set respectively. If the PUSCH is indicated to be associated with the two SRS resource sets simultaneously, antenna port 0 and 1 of a non-NCJT PUSCH are SRS port 0 and 1 of two associated SRS resources from the two SRS resources, and the two SRS ports from two SRS resource sets will be mapped to one antenna port of the PUSCH.

For NCJT PUSCH in Case 2-2, the maxRank will be configured to be 2, 3, or 4 due to the antenna port number being 4. When dynamic switch between NCJT PUSCH and non-NCJT PUSCH is supported, the maxRank can be configured according to the above illustrated three solutions of maxRank, wherein the real maxRank for NCJT PUSCH is 2, 3 or 4 while the real maxRank for non-PUSCH other can only be 1 or 2 due to SRS port number being 2.

Regarding the field of indicating precoding information and layer number, it can also be one or two. In the case that there are two fields of indicating precoding information and layer number, there are further two solutions considering that each precoding matrix, e.g., TPMI can be associated with 4 antenna ports or two antenna ports.

Scheme 2-2-1: One field of indicating precoding information and layer number or two fields of indicating precoding information and layer number but only one being valid for NCJT PUSCH

According to some embodiments of the present application, the one field of indicating precoding information and layer number can be an enhanced “precoding information and number of layers” field compared with the legacy “precoding information and number of layers” field. Similar to Scheme 2-1-1, the enhanced “precoding information and number of layers” field includes one rank combination indication and a legacy “precoding information and number of layers” indication. The rank combination indication indicates how many layers are associated with the first and second indicated SRS resource sets respectively.

Specifically, the precoding matrix for the NCJT PUSCH can be formulated as:

$$S = p ( \begin{matrix}x 1 \\ x 2\end{matrix} ) = ( p 1 p 2 ) ( \begin{matrix}x 1 \\ x 2\end{matrix} ) = p 1 x 1 + p 2 x 2$$

Wherein, x1, x2 are two sets of layers from two panels. p1 will be applied over the first set of layers x1 and correspond to two associated SRS resources where the first set of layers x1 is transmitted by SRS ports of the associated SRS resources of the PUSCH in the first associated SRS resource set, and p2 will be applied over the second set of layers x2 and correspond to the two associated SRS resources where the second set of layers x2 is transmitted by SRS ports of the associated SRS resources of the PUSCH in the second associated SRS resource set. The field of enhanced precoding information and layer number will indicate p and the combination of the number of the first and second set of layers for NCJT PUSCH transmission.

In the case that maxRank is 2, the rank combination for NCJT PUSCH will be (1+1), and the bit width of rank combination for NCJT PUSCH is 0. Two layers can be transmitted in a NCJT PUSCH, and one precoding matrix with rank=2 and antenna port=4 will be indicated for the NCJT PUSCH. Accordingly, each of x1 and x2 is a 1×1 vector, p is a 4×2 matrix, and each of p1 and p2 is a 4×1 vector.

In the case that maxRank is 3, the rank combination for NCJT PUSCH can be (1+1), (1+2) or (2+1). Two or three layers can be transmitted in a NCJT PUSCH. Thus, one precoding matrix with rank being 2 or 3 and antenna port being 4 will be indicated for the NCJT PUSCH. Accordingly, each of x1 and x2 can be a 1×1 or 2×1 vector, p is a 4×2 matrix or 4×3 matrix, and each of p1 and p2 is a 4×1 vector or a 4×2 vector.

In the case that maxRank is 4, the rank combination for NCJT PUSCH can be (1+1), (1+2), (2+1) or (2+2). Two, three or four layers can be transmitted in a NCJT PUSCH, and one precoding matrix with rank being 2, 3, or 4 and antenna port being 4 will be indicated for the NCJT PUSCH. Accordingly, x1 and x2 can be a 1×1 or 2×1 vector, p is a 4×2, 4×3 or 4×4 matrix, and each of p1 and p2 is a 4×1 or 4×2 vector.

In addition, the mapping between PUSCH antenna ports and SRS ports from two associated SRS resource sets can be fixed or flexible.

If the mapping between PUSCH antenna ports and SRS ports from two associated SRS resource sets is fixed, a first PUSCH antenna port and a third PUSCH antenna port are two SRS resource ports of a first associated SRS resource of the PUSCH within a first SRS resource set of the two SRS resource sets for transmitting a first set of layers of the PUSCH, and a second PUSCH antenna port and a fourth PUSCH antenna port are two SRS resource ports of a second associated SRS resource of the PUSCH within a second SRS resource set of the two SRS resource sets for transmitting a second set of layers of the PUSCH. For example, antenna ports 0 and 2 of a NCJT PUSCH are SRS port 0 and 1 of the first associated SRS resource set of the NCJT PUSCH and antenna ports 1 and 3 are SRS port 0 and 1 of the second associated SRS resource set of the NCJT PUSCH.

Since the first set of layers x1 can only be transmitted with the first associated SRS resource ports which are the same for both the first and third PUSCH antenna ports (e.g., antenna ports 0 and 2), the elements of the second and fourth rows of pl will be zero which means the first set of layers x1 will not be transmitted with the second associated SRS resource ports which are same for the PUSCH antenna ports 1 and 3. Similarly, the second set of layers x2 can only be transmitted with the second associated SRS resource ports which are the same for both the second and fourth PUSCH antenna ports (e.g., antenna ports 1 and 3), and thus the elements of first and third rows of p2 will be zero which means the second set of layers x2 will not be transmitted with the first associated SRS resource ports which are the same for both PUSCH antenna ports 1 and 3.

In the case that the mapping between PUSCH antenna ports and SRS ports from two associated SRS resource sets is flexible, since the first set of layers x1 can only be transmitted with the first associated SRS resource ports which will be mapped to two PUSCH antenna ports, two elements of pl will be zero which means the first set of layers x1 will not be transmitted with the second associated SRS resource ports which will be mapped to the remaining two PUSCH antenna ports. Similarly, the second set of layers x2 can only be transmitted with the second associated SRS resource ports which will be mapped to the remaining two PUSCH antenna ports, and two elements of p2 will be zero which means the second set of layers x2 will not be transmitted with the first associated SRS resource ports which will be mapped to the two PUSCH antenna ports.

The precoding matrix in Table 6.3.1.5-5 of TS38.211 (reproduced below) for two-layer transmission using four antenna ports and the precoding matrix in Table 6.3.1.5-6 of TS38.211 (reproduced below) for three-layer transmission using four antenna ports and the precoding matrix in Table 6.3.1.5-7 of TS38.211 (reproduced below) for four-layer transmission using four antenna ports can be selected for NCJT PUSCH according to the maxRank configuration.

TABLE 6.3.1.5-5
Precoding matrix W for
two-layer transmission using four antenna ports with transform precoding disabled

| TPMI | W | | | |
|---|---|---|---|---|
| index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

TABLE 6.3.1.5-6
Precoding matrix w for
three-layer transmission using four antenna ports with transform precoding disabled

| TPMI | w | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

TABLE 6.3.1.5-7
Precoding matrix w for
four-layer transmission using four antenna ports with transform precoding disabled

| TPMI | w | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

Specifically, in the case that the mapping between PUSCH antenna ports and SRS ports from two associated SRS resource sets is fixed, the precoding matrix indicated in the field of indicating precoding information and layer number can be determined from one of the following available precoding matrixes.

In the case that codebookSubset is configured to fullyAndPartialAndNonCoherent and ul-FullPowerTransmission is not configured or configured to fullpowerMode2 or configured to fullpower, then
if maxRank is 2, the available precoding matrixes for NCJT PUSCH are TPMI index with 0, 2, 5-13 in Table 6.3.1.5-5 for two-layer transmission using four antenna ports. The bit width of the field of “precoding information and layer number” will be 4; and the bit width of the enhanced field of “precoding information and layer number” will be 4 wherein the bit width of rank combination indication is 0;
if maxRank is 3, the available precoding matrixes for NCJT PUSCH are TPMI index with 0, 2, 5-13 in Table 6.3.1.5-5 for two-layer transmission using four antenna ports and TPMI index with 1-2 in Table 6.3.1.5-6 for three-layer transmission using four antenna ports. The rank combination can only be (1+1) and (1+2) according to the available precoding matrixes. The bit width of the field of “precoding information and layer number” will be 4; and the bit width of the enhanced field of “precoding information and layer number” will be 5 wherein the bit width of rank combination indication is 1; and
if maxRank is 4, the available precoding matrixes for NCJT PUSCH are TPMI index with 0, 2, 5-13 in Table 6.3.1.5-5 for two-layer transmission using four antenna ports, TPMI index with 1-2 in Table 6.3.1.5-6 for three-layer transmission using four antenna ports and TPMI index with 1-2 in Table 6.3.1.5-7 for four-layer transmission using four antenna ports. Since the rank combination can be (1+1), (1+2) and (2+2) according to the available precoding matrixes, the bit width of the field considering each rank combination will be 2. That is, the bit width of the field of “precoding information and layer number” will be 4; and the bit width of the enhanced “precoding information and layer number” field will 6 wherein the bit width of rank combination indication is 2.

In the case that codebookSubset is configured to nonCoherent and ul-FullPowerTransmission is not configured or configured to fullpowerMode2 or configured to fullpower, then
if maxRank is 2, the available precoding matrixes for NCJT PUSCH are TPMI index with 0, 2 and 5 in Table 6.3.1.5-5 for two-layer transmission using four antenna ports. The bit width of the field of “precoding information and layer number” will be 2 and the bit width of the enhanced field of “precoding information and layer number” field is 2 wherein the bit width of rank combination indication is 0;
if maxRank is 3, the available precoding matrixes for NCJT PUSCH are TPMI index with 0, 2 and 5 in Table 6.3.1.5-5 for two-layer transmission using four antenna ports. The rank combination can be (1+1) according to the available precoding matrixes, and thus, and thus the bit width of rank combination is 0. The bit width of the field of “precoding information and layer number” will be 2; and the bit width of the enhanced field of “precoding information and layer number” will be 2 wherein the bit width of rank combination indication is 0; or if maxRank is 4, the available precoding matrixes for NCJT PUSCH are TPMI index with 0, 2 and 5 in Table 6.3.1.5-5 for two-layer transmission using four antenna ports. The rank combination can be (1+1) according to the available precoding matrixes, and thus, and thus the bit width of rank combination is 0. The bit width of the field of “precoding information and layer number” will be 2; and the bit width of the enhanced field of “precoding information and layer number” will be 2 wherein the bit width of rank combination indication is 0.

In the case that codebookSubset is configured to nonCoherent and ul-FullPowerTransmission is configured to fullpowerModel, then
if maxRank is 2, the available precoding matrixes for NCJT PUSCH are TPMI index with 0, 2, 5 and 6 with in Table 6.3.1.5-5 for two-layer transmission using four antenna ports. The bit width of the field of “precoding information and layer number” will be 2 and the bit width of the enhanced field of “precoding information and layer number” will be 2 wherein the bit width of rank combination indication is 0;
if maxRank is 3, the available precoding matrixes for NCJT PUSCH are TPMI index with 0, 2, 5 and 6 with in Table 6.3.1.5-5 for two-layer transmission using four antenna ports and TPMI index with 1 in Table 6.3.1.5-6 for three-layer transmission using four antenna ports. The rank combination can be (1+1), (1+2) according to the available precoding matrixes, and thus the bit width of rank combination is 1. The bit width of the field of “precoding information and layer number” will be 3 and the bit width of the enhanced field of “precoding information and layer number” will be 4 wherein the bit width of rank combination indication is 1; or
if maxRank is 4, the available precoding matrixes for NCJT PUSCH are TPMI index with 0, 2, 5 and 6 with in Table 6.3.1.5-5 for two-layer transmission using four antenna ports and TPMI index with 1 in Table 6.3.1.5-6 for three-layer transmission using four antenna ports. The rank combination can be (1+1), (1+2) according to the available precoding matrixes, and thus the bit width of rank combination is 1. The bit width of the field of “precoding information and layer number” will 3 and the bit width of the enhanced field of “precoding information and layer number” will be 4 wherein the bit width of rank combination indication is 1.

In the case that the mapping between PUSCH antenna ports and SRS ports from two associated SRS resource sets is flexible, the precoding matrix (represented by TPMI index) indicated in the field of indicating precoding information and layer number can be determined from one of the following available precoding matrixes.

In the case that codebookSubset is configured to fullyAndPartialAndNonCoherent, and ul-FullPowerTransmission is not configured or configured to fullpowerMode2 or configured to fullpower, then
if maxRank is 2, the available precoding matrixes for NCJT PUSCH are TPMI index with 0-13 in Table 6.3.1.5-5 for two-layer transmission using four antenna ports. The bit width of the field of “precoding information and layer number” will be 4; and the bit width of the enhanced field of “precoding information and layer number” will be 4 wherein the bit width of rank combination indication is 0;
if maxRank is 3, the available precoding matrixes for NCJT PUSCH are TPMI index with 0-13 in Table 6.3.1.5-5 for two-layer transmission using four antenna ports and TPMI index with 0-2 in Table 6.3.1.5-6 for three-layer transmission using four antenna ports. The rank combination can be (1+1), (1+2) and (2+1) according to the available precoding matrixes, and thus the bit width of rank combination is 2. The bit width of the field of “precoding information and layer number” will be 5; and the bit width of the enhanced field of “precoding information and layer number” will be 7 wherein the bit width of rank combination indication is 2; or
if maxRank is 4, the available precoding matrixes for NCJT PUSCH are TPMI index with 0-13 in Table 6.3.1.5-5 for two-layer transmission using four antenna ports, TPMI index with 0-2 in Table 6.3.1.5-6 for three-layer transmission using four antenna ports and TPMI index with 0-2 in Table 6.3.1.5-7 for four-layer transmission using four antenna ports. The rank combination can be (1+1), (1+2), (2+1) and (2+2) according to the available precoding matrixes, and thus the bit width of rank combination is 2. The bit width of the field of “precoding information and layer number” will be 5 and the bit width of the enhanced field of “precoding information and layer number” will be 7 wherein the bit width of rank combination indication is 2.

In the case that codebookSubset is configured to nonCoherent, and ul-FullPowerTransmission is not configured or configured to fullpowerMode2 or configured to fullpower, then
if maxRank is 2, the available precoding matrixes for NCJT PUSCH are TPMI index with 0-5 in Table 6.3.1.5-5 for two-layer transmission using four antenna ports. The bit width of the field of “precoding information and layer number” will be 3; and the bit width of the enhanced field of “precoding information and layer number” will be 3 wherein the bit width of rank combination indication is 0;
if maxRank is 3, the available precoding matrixes for NCJT PUSCH are TPMI index with 0-5 in Table 6.3.1.5-5 for two-layer transmission using four antenna ports and TPMI index with 0 in Table 6.3.1.5-6 for three-layer transmission using four antenna ports. The rank combination can be (1+1), (1+2) and (2+1) according to the available precoding matrixes, and thus the bit width of rank combination is 2. The bit width of the field of “precoding information and layer number” will be 3 and the bit width of the enhanced field of “precoding information and layer number” will be 5 wherein the bit width of rank combination indication is 2; or
if maxRank is 4, the available precoding matrixes for NCJT PUSCH are TPMI index with 0-5 in Table 6.3.1.5-5 for two-layer transmission using four antenna ports, TPMI index with 0 in Table 6.3.1.5-6 for three-layer transmission using four antenna ports, and TPMI index with 0 in Table 6.3.1.5-7 for four-layer transmission using four antenna ports. The rank combination can be (1+1), (1+2), (2+1) and (2+2) according to the available precoding matrixes, and thus the bit width of rank combination is 2. The bit width of the field of “precoding information and layer number” will be 3 and the bit width of the enhanced field of “precoding information and layer number” will be 5 wherein the bit width of rank combination indication is 2.

In the case that codebookSubset is configured to nonCoherent, and ul-FullPowerTransmission is configured to fullpowerModel, then
if maxRank is 2, the available precoding matrixes for NCJT PUSCH are TPMI index with 0-6 with in Table 6.3.1.5-5 for two-layer transmission using four antenna ports. The bit width of the field of “precoding information and layer number” will be 3; and the bit width of the enhanced field of “precoding information and layer number” will be 3 wherein the bit width of rank combination indication is 0;
if maxRank is 3, the available precoding matrixes for NCJT PUSCH are TPMI index with 0-6 with in Table 6.3.1.5-5 for two-layer transmission using four antenna ports and TPMI index with 0-1 in Table 6.3.1.5-6 for three-layer transmission using four antenna ports. The rank combination can be (1+1), (1+2) and (2+1) according to the available precoding matrixes, and thus, the bit width of rank combination is 2. The bit width of the field of “precoding information and layer number” will be 4; and the bit width of the enhanced field of “precoding information and layer number” will be 6 wherein the bit width of rank combination indication is 2; or
if maxRank is 4, the available precoding matrixes for NCJT PUSCH are TPMI index with 0-6 with in Table 6.3.1.5-5 for two-layer transmission using four antenna ports, TPMI index with 0-1 in Table 6.3.1.5-6 for three-layer transmission using four antenna ports and TPMI index with 0 in Table 6.3.1.5-7 for four-layer transmission using four antenna ports. The rank combination can be (1+1), (1+2), (2+1) and (2+2) according to the available precoding matrixes, and thus the bit width of rank combination is 2. The bit width of the field of “precoding information and layer number” will be 4 and the bit width of the enhanced field of “precoding information and layer number” will be 6 wherein the bit width of rank combination indication is 2.

When there are two fields of indicating precoding information and layer number but only one is valid, details of the one field illustrated above can be applied to the only one valid field, and thus will not be repeated.

### Scheme 2-2-2: Two Valid Fields of Indicating Precoding Information and Layer Number, and the Antenna Port Number of Each Precoding Matrix is 4

According to some embodiments of the present application, the two fields of indicating precoding information and layer number can be two legacy “precoding information and number of layers” fields.

Each precoding matrix on each panel indicated by each field of indicating precoding information and layer number will be formulated as

$$S = ( p 1 p 2 ) ( \begin{matrix}x 1 \\ x 2\end{matrix} ) = p 1 x 1 + p 2 x 2$$

Wherein, x1, x2 are two sets of layers from two panels. p1 will be applied over the first set of layers x1 and correspond to the two associated SRS resources where the first set of layers x1 is only transmitted by SRS ports of the first associated SRS resource set, and p2 will be applied over the second set of layers x2 and correspond to the two associated SRS resources where the second set of layers x2 is only transmitted by SRS ports of the second associated SRS resource set. The first field of indicating precoding information and layer number indicates p1 and the number of the first set of layers associated with p1, while the second field of indicating precoding information and layer number indicates p2 and the number of the second set of layers associated with p2.

Similar to Scheme 2-2-1, in the case that maxRank is 2, the rank combination for NCJT PUSCH will be (1+1), and the bit width of rank combination for NCJT PUSCH is 0. Two layers can be transmitted in a NCJT PUSCH, and one precoding matrix with rank=2 and antenna port=4 will be indicated for the NCJT PUSCH. Accordingly, each of x1 and x2 is a 1×1 vector, and each of p1 and p2 is a 4×1 vector.

In the case that maxRank is 3, the rank combination for NCJT PUSCH will be (1+1), (1+2) or (2+1). Two or three layers can be transmitted in a NCJT PUSCH. Thus, one precoding matrix with rank being 2 or 3 and antenna port being 4 will be indicated for the NCJT PUSCH. Accordingly, each of x1 and x2 can be a 1×1 or 2×1 vector, and each of p1 and p2 is a 4×1 vector or a 4×2 vector.

In the case that maxRank is 4, the rank combination for NCJT PUSCH will be (1+1), (1+2), (2+1) or (2+2). Two, three or four layers can be transmitted in a NCJT PUSCH, and one precoding matrix with rank being 2, 3, or 4 and antenna port being 4 will be indicated for the NCJT PUSCH. Accordingly, x1 and x2 can be a 1×1 or 2×1 vector, and each of p1 and p2 is a 4×1 or 4×2 vector.

In addition, the mapping between PUSCH antenna ports and SRS ports from two associated SRS resource sets can be fixed or flexible, which is identical to Scheme 2-2-1.

The precoding matrix in Table 6.3.1.5-3 of T38.211 (reproduced below) for single-layer transmission using four antenna ports and the precoding matrix in Table 6.3.1.5-5 of TS38.211 for two-layer transmission using four antenna ports can be selected for NCJT PUSCH according to maxRank configuration. Based on the analysis above, there is the same limitation to p1 and p2 as Scheme 2-2-1.

TABLE 6.3.1.5-3
Precoding matrix w for
single-layer transmission using four antenna ports with transform precoding disabled.

| TPMI | w | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

Specifically, in the case that the mapping between PUSCH antenna ports and SRS ports from two associated SRS resource sets is fixed, the precoding matrix indicated in the first and second fields of indicating precoding information and layer number can respectively be determined from one of the following available precoding matrixes.

In the case that codebookSubset is configured to fullyAndPartialAndNonCoherent and ul-FullPowerTransmission is not configured or configured to fullpowerMode2 or configured to fullpower, then
if maxRank is 2, the available first precoding matrixes for NCJT PUSCH (available precoding matrixes for NCJT PUSCH in the first field of indicating precoding information and layer number, hereafter the same) are TPMI index with 0, 2, and 4-7 in Table 6.3.1.5-3 for single-layer transmission using four antenna ports, and the available second precoding matrixes for NCJT PUSCH (available precoding matrixes for NCJT PUSCH in the second field of indicating precoding information and layer number, hereafter the same) are TPMI index 1, 3 and 8-11 in Table 6.3.1.5-3 for single-layer transmission using four antenna ports. The bit width of each of the first and second field of “precoding information and layer number” will be 3 and the total bit width of the two fields will be 6; or
if maxRank is 3 or 4, the available first precoding matrixes for NCJT PUSCH are TPMI index with 0, 2, and 4-7 in Table 6.3.1.5-3 for single-layer transmission using four antenna ports and TPMI index with 1 in Table 6.3.1.5-5 for two-layer transmission using four antenna ports, and the available second precoding matrixes for NCJT PUSCH are TPMI index 1, 3 and 8-11 in Table 6.3.1.5-3 for single-layer transmission using four antenna ports and TPMI index with 4 in Table 6.3.1.5-5 for two-layer transmission using four antenna ports. The bit width of each of the first and second field of “precoding information and layer number” will be 3 and the total bit width of the two fields will be 6;

In the case that codebookSubset is configured to nonCoherent and ul-FullPowerTransmission is not configured or configured to fullpowerMode2 or configured to fullpower, then
if maxRank is 2, the available first precoding matrixes for NCJT PUSCH are TPMI index with 0 and 2 in Table 6.3.1.5-3 for single-layer transmission using four antenna ports, and the available second precoding matrixes for NCJT PUSCH are TPMI index 1 and 3 in Table 6.3.1.5-3 for single-layer transmission using four antenna ports. The bit width of each of the first and second field of “precoding information and layer number” will be 1 and the total bit width of the two fields will be 2; or
if maxRank is 3 or 4, the available first precoding matrixes for NCJT PUSCH are TPMI index with 0 and 2 in Table 6.3.1.5-3 for single-layer transmission using four antenna ports and TPMI index with 1 in Table 6.3.1.5-5 for two-layer transmission using four antenna ports, and the available second precoding matrixes for NCJT PUSCH are TPMI index 1 and 3 in Table 6.3.1.5-3 for single-layer transmission using four antenna ports and TPMI index with 4 in Table 6.3.1.5-5 for two-layer transmission using four antenna ports. The bit width of each of the first and second field of “precoding information and layer number” will be 2 and the total bit width of the two fields will be 4.

In the case that codebookSubset is configured to nonCoherent and ul-FullPowerTransmission is configured to fullpowerModel, then
if maxRank is 2, the available first precoding matrixes for NCJT PUSCH are TPMI index with 0 and 2 in Table 6.3.1.5-3 for single-layer transmission using four antenna ports, and the available second precoding matrixes for NCJT PUSCH are TPMI index 1 and 3 in Table 6.3.1.5-3 for single-layer transmission using four antenna ports. The bit width of each of the first and second field of “precoding information and layer number” will be 1, and the total bit width of the two fields will be 2; or
If maxRank is 3 or 4, the available first precoding matrixes for NCJT PUSCH are TPMI index with 0 and 2 in Table 6.3.1.5-3 for single-layer transmission using four antenna ports and TPMI index with 1 in Table 6.3.1.5-5 for two-layer transmission using four antenna ports, and the available second precoding matrixes for NCJT PUSCH are TPMI index 1 and 3 in Table 6.3.1.5-3 for single-layer transmission using four antenna ports and TPMI index with 4 in Table 6.3.1.5-5 for two-layer transmission using four antenna ports. The bit width of each of the first and second field of “precoding information and layer number” will be 2 and the total bit width of the two fields will be 4.

In the case that the mapping between PUSCH antenna ports and SRS ports from two associated SRS resource sets is flexible, the precoding matrix (represented by TPMI index) indicated in each of the first and second field of indicating precoding information and layer number can respectively be determined from one of the following available precoding matrixes.

Specifically, in the case that codebookSubset is configured to fullyAndPartialAndNonCoherent and ul-FullPowerTransmission is not configured or configured to fullpowerMode2 or configured to fullpower, then
if maxRank is 2, the available precoding matrixes for NCJT PUSCH are TPMI index 0-11 in Table 6.3.1.5-3 for single-layer transmission using four antenna ports. The bit width of each of the first and second field of “precoding information and layer number” will be 4 and the total bit width of the two fields will be 8; or
if maxRank is 3 or 4, the available precoding matrixes for NCJT PUSCH are TPMI index with 0-11 in Table 6.3.1.5-3 for single-layer transmission using four antenna ports and TPMI index with 0-5 in Table 6.3.1.5-5 for two-layer transmission using four antenna ports. The bit width of each of the first and second field of “precoding information and layer number” will be 5 and the total bit width of the two fields will be 10.

In the case that codebookSubset is configured to nonCoherent and ul-FullPowerTransmission is not configured or configured to fullpowerMode2 or configured to fullpower, then
if maxRank is 2, the available precoding matrixes for NCJT PUSCH are TPMI index with 0-3 in Table 6.3.1.5-3 for single-layer transmission using four antenna ports. The bit width of each of the first and second field of “precoding information and layer number” will be 2 and the total bit width of the two fields will be 4; or
if maxRank is 3 or 4, the available precoding matrixes for NCJT PUSCH are TPMI index with 0-3 in Table 6.3.1.5-3 for single-layer transmission using four antenna ports and TPMI index with 0-5 in Table 6.3.1.5-5 for two-layer transmission using four antenna ports. The bit width of each of the first and second field of “precoding information and layer number” will be 4 and the total bit width of the two fields will be 8.

In the case that codebookSubset is configured to nonCoherent and ul-FullPowerTransmission is configured to fullpowerModel, then
if maxRank is 2, the available precoding matrixes for NCJT PUSCH are TPMI index 0-3 in Table 6.3.1.5-3 for single-layer transmission using four antenna ports. The bit width of each of the first and second field of “precoding information and layer number” will be 2 and the total bit width of the two fields will be 4; or
if maxRank is 3 or 4, the available precoding matrixes for NCJT PUSCH are TPMI index with 0-3 in Table 6.3.1.5-3 for single-layer transmission using four antenna ports and TPMI index with 0-5 in Table 6.3.1.5-5 for two-layer transmission using four antenna ports. The bit width of each of the first and second field of “precoding information and layer number” will be 4 and the total bit width of the two fields will be 8.

### Scheme 2-2-3: Two Valid Fields of Indicating Precoding Information and Layer Number, and the Antenna Port Number of Each Indicated Precoding Matrix is 2

In Scheme 2-2-3, although the PUSCH antenna port is 4, the antenna port of each precoding matrix is 2.

According to some embodiments of the present application, the two fields of indicating precoding information and layer number can be two legacy “precoding information and number of layers” fields.

Each precoding matrix on each panel indicated by each field of indicating precoding information and layer number will be formulated as

$$S = ( \begin{matrix}p 1 & 0 \\ 0 & p 2\end{matrix} ) ( \begin{matrix}x 1 \\ x 2\end{matrix} ) = ( \begin{matrix}p 1 x 1 \\ p 2 x 2\end{matrix} )$$

Wherein x1, x2 are two sets of layers from two panels. p1 will be applied over the first set of layers x1 and correspond to the first associated SRS resources where the first set of layers x1 is only transmitted by SRS ports of the first associated SRS resource, and p2 will be applied over the second set of layers x2 and corresponds to the second associated SRS resource where the second set of layers x2 is only transmitted by SRS ports of the second associated SRS resource. The first field of indicating precoding information and layer number indicates p1 and the number of the first set of layers associated with p1, while the second field of indicating precoding information and layer number indicates p2 and the number of the second set of layers associated with p2. Thus, the first and second PUSCH antenna ports are two SRS ports of the first associated SRS resource while the third and fourth PUSCH antenna ports are two SRS ports of the second associated SRS resource.

Similar to Scheme 2-2-2, in the case that maxRank is 2, the rank combination for NCJT PUSCH will be (1+1). Two layers can be transmitted in a NCJT PUSCH, and one precoding matrix with rank=2 and antenna port=4 will be indicated for the NCJT PUSCH. Accordingly, each of x1 and x2 is a 1×1 vector and each of p1 and p2 is a 4×1 vector.

In the case that maxRank is 3, the rank combination for NCJT PUSCH will be (1+1), (1+2) or (2+1). Two or three layers can be transmitted in a NCJT PUSCH. Thus, one precoding matrix with rank being 2 or 3 and antenna port being 4 will be indicated for the NCJT PUSCH. Accordingly, each of x1 and x2 can be a lxi or 2×1 vector, and each of p1 and p2 is a 4×1 vector or a 4×2 vector.

In the case that maxRank is 4, the rank combination for NCJT PUSCH will be (1+1), (1+2), (2+1) or (2+2). Two, three or four layers can be transmitted in a NCJT PUSCH, and one precoding matrix with rank being 2, 3, or 4 and antenna port being 4 will be indicated for the NCJT PUSCH. Accordingly, x1 and x2 can be a 1×1 or 2×1 vector, and each of p1 and p2 is a 4×1 or 4×2 vector.

The precoding matrixes in Table 6.3.1.5-1 of TS38.211 for single-layer transmission using two antenna ports and Table 6.3.1.5-4 of TS38.211 for two-layer transmission using two antenna ports can be selected for NCJT PUSCH according to maxRank configuration. Each precoding matrix indicated in the first or the second field of indicating precoding information and layer number can be determined to be one of the following available precoding matrixes.

Specifically, in the case that codebookSubset is configured to fullyAndPartialAndNonCoherent and ul-FullPowerTransmission is not configured or configured to fullpowerMode2 or configured to fullpower, then
if maxRank is 2, the available precoding matrixes for NCJT PUSCH are TPMI index 0-5 in Table 6.3.1.5-1 for single-layer transmission using two antenna ports. The bit width of each of the first and second field of “precoding information and layer number” will be 3 and the total bit width of the two fields will be 6; or
if maxRank=3 or 4, the available precoding matrixes for NCJT PUSCH are TPMI index 0-5 in Table 6.3.1.5-1 for single-layer transmission using two antenna ports and TPMI index 0-2 in Table 6.3.1.5-4 for two-layer transmission using two antenna ports. The bit width of each of the first and second fields of “Precoding information and layer number” will be 4 and the total bit width of the two fields will be 8.

In the case that codebookSubset is configured to nonCoherent and ul-FullPowerTransmission is not configured or configured to fullpowerMode2 or configured to fullpower, then
if maxRank=2, the available precoding matrixes for NCJT PUSCH are TPMI index 0-1 in Table 6.3.1.5-1 for single-layer transmission using two antenna ports. The bit width of each of the first and second field of “precoding information and layer number” will be 1 and the total bit width of the two fields will be 2; or
if maxRank is 3 or 4, the available precoding matrixes for NCJT PUSCH are TPMI index 0-1 in Table 6.3.1.5-1 for single-layer transmission using two antenna ports and TPMI index 0 in Table 6.3.1.5-4 for two-layer transmission using two antenna ports. The bit width of each of the first and second field of “precoding information and layer number” will be 2 and the total bit width of the two fields will be 4; or

In the case that codebookSubset is configured to nonCoherent and ul-FullPowerTransmission is configured to fullpowerModel, then
if maxRank is 2, the available precoding matrixes for NCJT PUSCH are TPMI index 0-2 in Table 6.3.1.5-1 for single-layer transmission using two antenna ports. The bit width of each of the first and second field of “precoding information and layer number” will be 2 and the total bit width of the two fields will be 4; or
If maxRank is 3 or 4, the available precoding matrixes for NCJT PUSCH are TPMI index 0-2 in Table 6.3.1.5-1 for single-layer transmission using two antenna ports and TPMI index 0 in Table 6.3.1.5-4 for two-layer transmission using two antenna ports. The bit width of each of the first and second field “Precoding information and layer number” will be 2 and the total bit width of the two fields will be 4.

### Scenario III: SRS Ports are Configured Per SRS Resource Set

Since only 4 antenna ports will be supported in NCJT PUSCH transmission in Rel-18, PUSCH antenna ports will be 4, wherein the antenna port number of the NCJT PUSCH is the same as the SRS port number per SRS resource set. For example, if a NCJT PUSCH is indicated to be associated with one SRS resource set, antenna ports 0-3 of the NCJT PUSCH are the four SRS ports of one associated SRS resource of the one SRS resource set; or if the NCJT PUSCH is indicated to be associated with two SRS resource sets simultaneously, antenna ports 0-3 of the NCJT PUSCH are the four SRS ports of two associated SRS resources of the two SRS resource sets. In addition, it can be seen that two SRS ports from the two SRS resource sets will be mapped to one antenna port of the PUSCH if it is indicated to be associated with two SRS resource sets simultaneously.

For NCJT PUSCH in Scenario III, the maxRank will be configured to be 2, 3 or 4 due to the antenna port number being 4. When dynamic switch between NCJT PUSCH and non-NCJT PUSCH is supported, according to Solution 1 of maxRank, the maxRank for PUSCH transmission can be configured to be 2, 3 or 4; and according to Solution 2 of maxRank, maxRank configured for NCJT PUSCH can be 2, 3 or 4.

Regarding the field of indicating precoding information and layer number, it can be one or two as illustrated below.

Scheme 3-1-1: One field of indicating precoding information and layer number or two fields of indicating precoding information and layer number but only one being valid for NCJT PUSCH

According to some embodiments of the present application, the one field of indicating precoding information and layer number can be an enhanced “precoding information and number of layers” field compared with the legacy “precoding information and number of layers” field. The enhanced “precoding information and number of layers” field includes one rank combination indication and a legacy “precoding information and number of layers” indication. The rank combination indication indicates how many layers are associated with the first and second indicated SRS resource sets respectively.

Specifically, the precoding matrix for the NCJT PUSCH can be formulated as:

$$S = p ( \begin{matrix}x 1 \\ x 2\end{matrix} ) = ( p 1 p 2 ) ( \begin{matrix}x 1 \\ x 2\end{matrix} ) = p 1 x 1 + p 2 x 2$$

Wherein x1, x2 are two sets of layers from two panels. p1 will be applied over the first set of layers x1 and correspond to the first associated SRS resource, and p2 will be applied over the second set of layers x2 and correspond to the second associated SRS resource. The field of indicating precoding information and layer number indicates p, and the combination of the first and second set layer number for NCJT PUSCH transmission.

In the case that maxRank is 2, the rank combination for NCJT PUSCH will be (1+1), and the bit width of rank combination for NCJT PUSCH is 0. Two layers can be transmitted in a NCJT PUSCH, and one precoding matrix with rank=2 and antenna port=4 will be indicated for the NCJT PUSCH. Accordingly, each of x1 and x2 is a 1×1 vector, p is a 4×2 matrix, and each of p1 and p2 is a 4×1 vector.

In the case that maxRank is 3, the rank combination for NCJT PUSCH will be (1+1), (1+2) or (2+1). Two or three layers can be transmitted in a NCJT PUSCH. Thus, one precoding matrix with rank being 2 or 3 and antenna port being 4 will be indicated for the NCJT PUSCH. Accordingly, each of x1 and x2 can be a 1×1 or 2×1 vector, p is a 4×2 matrix or 4×3 matrix, and each of p1 and p2 is a 4×1 vector or a 4×2 vector.

In the case that maxRank is 4, two, three or four layers can be transmitted in a NCJT PUSCH. Thus, one precoding matrix with rank being 2, 3, and 4 and antenna port=4 will be indicated for the NCJT PUSCH. In some embodiments of the present application the rank combination for NCJT PUSCH will be (1+1), (1+2), (2+1) or (2+2). Accordingly, x1 and x2 can be a lxi or 2×1 vector, p is a 4×2, 4×3 or 4×4 matrix, and each of p1 and p2 is a 4×1 or 4×2 vector. The rank combination indication needs 2 bits. However, in some other embodiments of the present application, the rank combination for NCJT PUSCH will be (1+1), (1+2), (2+1), (2+2), (1+3) and (3+1). Accordingly, x1 and x2 can be lxi, 2×1 or 3×1 vectors, p is a 4×2, 4×3 or 4×4 matrix, and each of p1 and p2 is a 4×1, 4×2 or 4×3 vector. The rank combination indication needs 3 bits.

The precoding matrixes in Table 6.3.1.5-5 of TS38.211 for two-layer transmission using four antenna ports and Table 6.3.1.5-6 of TS38.211 for three-layer transmission using four antenna ports and Table 6.3.1.5-7 of TS38.211 for four-layer transmission using four antenna ports can be selected for NCJT PUSCH according to the maxRank configuration.

In addition, according to legacy specification, when 4 SRS ports are configured for each SRS resource set, codebookSubset can be configured as fullyAndPartialAndNonCoherent, partialAndNonCoherent or nonCoherent; and only if codebookSubset is configured to partialAndNonCoherent or nonCoherent, ul-FullPowerTransmission can be configured to fullpowerModel.

Given the above, in the case that codebookSubset is configured to fullyAndPartialAndNonCoherent and ul-FullPowerTransmission is not configured or configured to fullpowerMode2 or configured to fullpower, then if maxRank is 2, the available precoding matrixes for NCJT PUSCH are TPMI index with 0-21 in Table 6.3.1.5-5 for two-layer transmission using four antenna ports. The precoding matrix determined from the field of indicating precoding information and layer number can be one of the available precoding matrixes. The bit width of “precoding information and layer number” field will be 5; and the bit width of enhanced “precoding information and layer number” field will be 5 wherein the bit width of rank combination indication is 0;
if maxRank is 3, the available precoding matrixes for NCJT PUSCH are TPMI index with 0-21 in Table 6.3.1.5-5 for two-layer transmission using four antenna ports and TPMI index with 0-6 in Table 6.3.1.5-6 for three-layer transmission using four antenna ports. The precoding matrix determined from the field of indicating precoding information and layer number can be one of the available precoding matrixes. The bit width of “precoding information and layer number” field will be 5 and the bit width of enhanced “precoding information and layer number” field will be 7 wherein the bit width of rank combination indication is 2; or
if maxRank is 4, the available precoding matrixes for NCJT PUSCH are TPMI index with 0-21 in Table 6.3.1.5-5 for two-layer transmission using four antenna ports, TPMI index with 0-6 in Table 6.3.1.5-6 for three-layer transmission using four antenna ports and TPMI index with 0-4 in Table 6.3.1.5-7 for four-layer transmission using four antenna ports. The precoding matrix determined from the field of indicating precoding information and layer number can be one of the available precoding matrixes. The bit width of “precoding information and layer number” field will be 6 and the bit width of enhanced “precoding information and layer number” field will be 8 or 9 wherein the bit width of rank combination indication is 2 or 3.

In the case that codebookSubset is configured to partialAndNonCoherent and ul-FullPowerTransmission is not configured or configured to fullpowerMode2 or configured to fullpower,
if maxRank is 2, the available precoding matrixes for NCJT PUSCH are TPMI index with 0-13 in Table 6.3.1.5-5 for two-layer transmission using four antenna ports. The precoding matrix determined from the field of indicating precoding information and layer number can be one of the available precoding matrixes. The bit width of “precoding information and layer number” field will be 4; and the bit width of enhanced “precoding information and layer number” field will be 4 wherein the bit width of rank combination indication is 0;
if maxRank is 3, the available precoding matrixes for NCJT PUSCH are TPMI index with 0-13 in Table 6.3.1.5-5 for two-layer transmission using four antenna ports and TPMI index with 0-2 in Table 6.3.1.5-6 for three-layer transmission using four antenna ports. The precoding matrix determined from the field of indicating precoding information and layer number can be one of the available precoding matrixes. The bit width of “precoding information and layer number” field will be 5; and the bit width of enhanced “precoding information and layer number” field will be 7 wherein the bit width of rank combination indication is 2; or
if maxRank is 4, the available precoding matrixes for NCJT PUSCH are TPMI index with 0-13 in Table 6.3.1.5-5 for two-layer transmission using four antenna ports, TPMI index with 0-2 in Table 6.3.1.5-6 for three-layer transmission using four antenna ports and TPMI index with 0-2 in Table 6.3.1.5-7 for four-layer transmission using four antenna ports. The precoding matrix determined from the field of indicating precoding information and layer number can be one of the available precoding matrixes. The bit width of “precoding information and layer number” field will be 5; and the bit width of enhanced “precoding information and layer number” field will be 7 or 8 wherein the bit width of rank combination indication is 2 or 3 correspondingly.

In the case that codebookSubset is configured to partialAndNonCoherent and ul-FullPowerTransmission is configured to fullpowerModel, then
if maxRank is 2, the available precoding matrixes for NCJT PUSCH are TPMI index with 0-13 in Table 6.3.1.5-5 for two-layer transmission using four antenna ports. The precoding matrix determined from the field of indicating precoding information and layer number can be one of the available precoding matrixes. The bit width of “precoding information and layer number” field will be 4; and the bit width of enhanced “precoding information and layer number” field will be 4 wherein the bit width of rank combination indication is 0;
if maxRank is 3, the available precoding matrixes for NCJT PUSCH are TPMI index with 0-13 in Table 6.3.1.5-5 for two-layer transmission using four antenna ports and TPMI index with 0-2 in Table 6.3.1.5-6 for three-layer transmission using four antenna ports. The precoding matrix determined from the field of indicating precoding information and layer number can be one of the available precoding matrixes. The bit width of “precoding information and layer number” field will be 5; and the bit width of enhanced “precoding information and layer number” field will be 7 wherein the bit width of rank combination indication is 2; or
if maxRank is 4, the available precoding matrixes for NCJT PUSCH are TPMI index with 0-13 in Table 6.3.1.5-5 for two-layer transmission using four antenna ports, TPMI index with 0-2 in Table 6.3.1.5-6 for three-layer transmission using four antenna ports and TPMI index with 0-2 in Table 6.3.1.5-7 for four-layer transmission using four antenna ports. The precoding matrix determined from the field of indicating precoding information and layer number can be one of the available precoding matrixes. The bit width of “precoding information and layer number” field will be 5; and the bit width of enhanced “precoding information and layer number” field will be 7 or 8 wherein the bit width of rank combination indication is 2 or 3.

In the case that codebookSubset is configured to nonCoherent and ul-FullPowerTransmission is not configured or configured to fullpowerMode2 or configured to fullpower, then
if maxRank is 2, the available precoding matrixes for NCJT PUSCH are TPMI index with 0-5 in Table 6.3.1.5-5 for two-layer transmission using four antenna ports. The precoding matrix determined from the field of indicating precoding information and layer number can be one of the available precoding matrixes. The bit width of “precoding information and layer number” field will be 3; and the bit width of enhanced “precoding information and layer number” field will be 3 wherein the bit width of rank combination indication is 0;
if maxRank is 3, the available precoding matrixes for NCJT PUSCH are TPMI index with 0-5 in Table 6.3.1.5-5 for two-layer transmission using four antenna ports and TPMI index with 0 in Table 6.3.1.5-6 for three-layer transmission using four antenna ports. The precoding matrix determined from the field of indicating precoding information and layer number can be one of the available precoding matrixes. The bit width of “precoding information and layer number” field will be 3; and the bit width of enhanced “precoding information and layer number” field will be 5 wherein the bit width of rank combination indication is 2; or
if maxRank is 4, the available precoding matrixes for NCJT PUSCH are TPMI index with 0-5 in Table 6.3.1.5-5 for two-layer transmission using four antenna ports, TPMI index with 0 in Table 6.3.1.5-6 for three-layer transmission using four antenna ports and TPMI index with 0 in Table 6.3.1.5-7 for four-layer transmission using four antenna ports. The precoding matrix determined from the field of indicating precoding information and layer number can be one of the available precoding matrixes. The bit width of “precoding information and layer number” field will be 3; and the bit width of enhanced “precoding information and layer number” field will be 5 or 6 wherein the bit width of rank combination indication is 2 or 3.

In the case that codebookSubset is configured to nonCoherent and ul-FullPowerTransmission is configured to fullpowerModel, then
if maxRank is 2, the available precoding matrixes for NCJT PUSCH are TPMI index with 0-6 in Table 6.3.1.5-5 for two-layer transmission using four antenna ports. The precoding matrix determined from the field of indicating precoding information and layer number can be one of the available precoding matrixes. The bit width of “precoding information and layer number” field will be 3; and the bit width of enhanced “precoding information and layer number” field will be 3 wherein the bit width of rank combination indication is 0;
if maxRank is 3, the available precoding matrixes for NCJT PUSCH are TPMI index with 0-6 in Table 6.3.1.5-5 for two-layer transmission using four antenna ports and TPMI index with 0-1 in Table 6.3.1.5-6 for three-layer transmission using four antenna ports. The precoding matrix determined from the field of indicating precoding information and layer number can be one of the available precoding matrixes. The bit width of “precoding information and layer number” field will be 4; and the bit width of enhanced “precoding information and layer number” field will be 6 wherein the bit width of rank combination indication is 2; or
if maxRank is 4, the available precoding matrixes for NCJT PUSCH are TPMI index with 0-6 in Table 6.3.1.5-5 for two-layer transmission using four antenna ports, TPMI index with 0-1 in Table 6.3.1.5-6 for three-layer transmission using four antenna ports and TPMI index with 0 in Table 6.3.1.5-7 for four-layer transmission using four antenna ports. The precoding matrix determined from the field of indicating precoding information and layer number can be one of the available precoding matrixes. The bit width of the field of “precoding information and layer number” will be 4; and the bit width of the enhanced field of “precoding information and layer number” will be 6 or 7 wherein the bit width of rank combination indication is 2 or 3.

When there are two fields of indicating precoding information and layer number but only one is valid for NCJT PUSCH, details of the one field illustrated above can be applied to the only one valid field, and thus will not be repeated.

### Scheme 3-1-2: Two Valid Fields of Indicating Precoding Information and Layer Number

According to some embodiments of the present application, the two fields of indicating precoding information and layer number can be two legacy “precoding information and number of layers” fields.

Each precoding matrix on each panel indicated by each field of indicating precoding information and layer number will be formulated as

$$S = ( p 1 p 2 ) ( \begin{matrix}x 1 \\ x 2\end{matrix} ) = p 1 x 1 + p 2 x 2$$

Wherein, x1, x2 are two sets of layers from two panels. p1 will be applied over the first set of layers x1 and correspond to the first associated SRS resource, and p2 will be applied over the second set of layers x2 and correspond to the second associated SRS resource. The first field of indicating precoding information and layer number indicates p1 and the first set layer number, while the second field of indicating precoding information and layer number indicates p2 and the second set layer number.

Similarly, in the case that maxRank is 2, the rank combination for NCJT PUSCH will be (1+1). Two layers can be transmitted in a NCJT PUSCH, and one precoding matrix with rank being 2 and antenna port being 4 will be indicated for the NCJT PUSCH. Accordingly, each of x1 and x2 is a 1×1 vector and each of p1 and p2 is a 4×1 vector.

In the case that maxRank is 3, the rank combination for NCJT PUSCH will be (1+1), (1+2) or (2+1). Two or three layers can be transmitted in a NCJT PUSCH. Thus, one precoding matrix with rank being 2 or 3 and antenna port being 4 will be indicated for the NCJT PUSCH. Accordingly, each of x1 and x2 can be a 1×1 or 2×1 vector, and each of p1 and p2 is a 4×1 vector or a 4×2 vector.

In the case that maxRank is 4, two, three or four layers can be transmitted in a NCJT PUSCH. Thus, one precoding matrix with rank being 2, 3, and 4 and antenna port=4 will be indicated for the NCJT PUSCH. In some embodiments of the present application the rank combination for NCJT PUSCH will be (1+1), (1+2), (2+1) or (2+2). Accordingly, x1 and x2 can be a 1×1 or 2×1 vector, and each of p1 and p2 is a 4×1 or 4×2 vector. However, in some other embodiments of the present application, the rank combination for NCJT PUSCH will be (1+1), (1+2), (2+1), (2+2), (1+3) and (3+1). Accordingly, x1 and x2 can be lxi, 2×1 or 3×1 vectors, and each of p1 and p2 is a 4×1, 4×2 or 4×3 vector.

The precoding matrix in Table 6.3.1.5-3 of TS38.211 for single-layer transmission using four antenna ports, Table 6.3.1.5-5 of TS38.211 for two-layer transmission using four antenna ports and Table 6.3.1.5-6 of TS38.211 for three-layer transmission using four antenna ports can be selected for NCJT PUSCH according to maxRank configuration.

In the case that codebookSubset is configured to fullyAndPartialAndNonCoherent and ul-FullPowerTransmission is not configured or configured to fullpowerMode2 or configured to fullpower, then
if maxRank is 2, the available precoding matrixes for NCJT PUSCH are TPMI index with 0-27 in Table 6.3.1.5-3 for single-layer transmission using four antenna ports. The precoding matrix determined from each of the first and second field of indicating precoding information and layer number can be one of the available precoding matrixes. The bit width of each field of “precoding information and layer number” will be 5, and the total bit width of the two fields of “Precoding information and layer number” will be 10;
if maxRank is 3 or 4 while not supporting rank combination (1+3) or (3+1), the available precoding matrixes for NCJT PUSCH are TPMI index with 0-27 in Table 6.3.1.5-3 for single-layer transmission using four antenna ports and TPMI index with 0-21 in Table 6.3.1.5-5 for two-layer transmission using four antenna ports. The precoding matrix determined from each of the first and second field of indicating precoding information and layer number can be one of the available precoding matrixes. The bit width of each field of “precoding information and layer number” will be 6, and thus the total bit width of the two fields of “Precoding information and layer number” will be 12; or
if maxRank is 4 supporting rank combination (1+3) or (3+1), the available precoding matrixes for NCJT PUSCH are TPMI index with 0-27 in Table 6.3.1.5-3 for single-layer transmission using four antenna ports, TPMI index with 0-21 in Table 6.3.1.5-5 for two-layer transmission using four antenna ports and TPMI index with 0-6 in Table 6.3.1.5-6 for three-layer transmission using four antenna ports. The precoding matrix determined from each of the first and second field of indicating precoding information and layer number can be one of the available precoding matrixes. The bit width of each field of “precoding information and layer number” will be 6, and thus, the total bit width of the two fields of “precoding information and layer number” will be 12.

In the case that codebookSubset is configured to partialAndNonCoherent and ul-FullPowerTransmission is not configured or configured to fullpowerMode2 or configured to fullpower, then
if maxRank is 2, the available precoding matrixes for NCJT PUSCH are TPMI index with 0-11 in Table 6.3.1.5-3 for single-layer transmission using four antenna ports. The precoding matrix determined from each of the first and second field of indicating precoding information and layer number can be one of the available precoding matrixes. The bit width of each field of “precoding information and layer number” will be 4, and thus, the total bit width of the two fields of “precoding information and layer number” will be 8;
if maxRank is 3 or 4 while not supporting rank combination (1+3) or (3+1), the available precoding matrixes for NCJT PUSCH are TPMI index with 0-11 in Table 6.3.1.5-3 for single-layer transmission using four antenna ports and TPMI index with 0-13 in Table 6.3.1.5-5 for two-layer transmission using four antenna ports. The precoding matrix determined from each of the first and second field of indicating precoding information and layer number can be one of the available precoding matrixes. The bit width of each field of “precoding information and layer number” will be 5, and thus, the total bit width of the two fields of “precoding information and layer number” will be 10; or
if maxRank is 4 supporting rank combination (1+3) or (3+1), the available precoding matrixes for NCJT PUSCH are TPMI index with 0-11 in Table 6.3.1.5-3 for single-layer transmission using four antenna ports, TPMI index with 0-13 in Table 6.3.1.5-5 for two-layer transmission using four antenna ports and TPMI index with 0-2 in Table 6.3.1.5-6 for three-layer transmission using four antenna ports. The precoding matrix determined from each of the first and second field of indicating precoding information and layer number can be one of the available precoding matrixes. The bit width of each field of “precoding information and layer number” will be 5, and thus, the total bit width of the two fields of “precoding information and layer number” will be 10.

In the case that codebookSubset is configured to partialAndNonCoherent and ul-FullPowerTransmission is configured to fullpowerModel, then
if maxRank is 2, the available precoding matrixes for NCJT PUSCH are TPMI index with 0-15 in Table 6.3.1.5-3 for single-layer transmission using four antenna ports. The precoding matrix determined from each of the first and second field of indicating precoding information and layer number can be one of the available precoding matrixes. The bit width of each field of “precoding information and layer number” will be 4, and thus, the total bit width of the two fields of “precoding information and layer number” will be 8;
if maxRank is 3 or 4 while not supporting rank combination (1+3) or (3+1), the available precoding matrixes for NCJT PUSCH are TPMI index with 0-15 in Table 6.3.1.5-3 for single-layer transmission using four antenna ports and TPMI index with 0-13 in Table 6.3.1.5-5 for two-layer transmission using four antenna ports. The precoding matrix determined from each of the first and second field of indicating precoding information and layer number can be one of the available precoding matrixes. The bit width of each field of “precoding information and layer number” will be 5, and thus, the total bit width of the two fields of “precoding information and layer number” will be 10; or
if maxRank is 4 supporting rank combination (1+3) or (3+1), the available precoding matrixes for NCJT PUSCH are TPMI index with 0-15 in Table 6.3.1.5-3 for single-layer transmission using four antenna ports, TPMI index with 0-13 in Table 6.3.1.5-5 for two-layer transmission using four antenna ports and TPMI index with 0-2 in Table 6.3.1.5-6 for three-layer transmission using four antenna ports. The precoding matrix determined from each of the first and second field of indicating precoding information and layer number can be one of the available precoding matrixes. The bit width of each field of “precoding information and layer number” will be 6, and thus, the total bit width of the two fields of “precoding information and layer number” will be 12.

In the case that codebookSubset is configured to nonCoherent and ul-FullPowerTransmission is not configured or configured to fullpowerMode2 or configured to fullpower, then
if maxRank is 2, the available precoding matrixes for NCJT PUSCH are TPMI index with 0-3 in Table 6.3.1.5-3 for single-layer transmission using four antenna ports. The precoding matrix determined from each of the first and second field of indicating precoding information and layer number can be one of the available precoding matrixes. The bit width of each field of “precoding information and layer number” will be 2, and thus, the total bit width of the two fields of “precoding information and layer number” will be 4;
if maxRank is 3 or 4 while not supporting rank combination (1+3) or (3+1), the available precoding matrixes for NCJT PUSCH are TPMI index with 0-3 in Table 6.3.1.5-3 for single-layer transmission using four antenna ports and TPMI index with 0-5 in Table 6.3.1.5-5 for two-layer transmission using four antenna ports. The precoding matrix determined from each of the first and second field of indicating precoding information and layer number can be one of the available precoding matrixes. The bit width of each field of “precoding information and layer number” will be 4, and thus, the total bit width of the two fields of “precoding information and layer number” will be 8; or
if maxRank is 4 supporting rank combination (1+3) or (3+1), the available precoding matrixes for NCJT PUSCH are TPMI index with 0-3 in Table 6.3.1.5-3 for single-layer transmission using four antenna ports, TPMI index with 0-5 in Table 6.3.1.5-5 for two-layer transmission using four antenna ports and TPMI index with 0 in Table 6.3.1.5-6 for three-layer transmission using four antenna ports. The precoding matrix determined from each of the first and second field of indicating precoding information and layer number can be one of the available precoding matrixes. The bit width of each field of “precoding information and layer number” will be 4, and thus, the total bit width of the two fields of “precoding information and layer number” will be 8.

In the case that codebookSubset is configured to nonCoherent and ul-FullPowerTransmission is configured to fullpowerModel, then
if maxRank is 2, the available precoding matrixes for NCJT PUSCH are TPMI index with 0-3 and 13 in Table 6.3.1.5-3 for single-layer transmission using four antenna ports. The precoding matrix determined from each of the first and second field of indicating precoding information and layer number can be one of the available precoding matrixes. The bit width of each field of “precoding information and layer number” will be 3, and thus, the total bit width of the two fields of “Precoding information and layer number” will be 6.
if maxRank is 3 or 4 while not supporting rank combination (1+3) or (3+1), the available precoding matrixes for NCJT PUSCH are TPMI index with 0-3 and 13 in Table 6.3.1.5-3 for single-layer transmission using four antenna ports and TPMI index with 0-6 in Table 6.3.1.5-5 for two-layer transmission using four antenna ports. The precoding matrix determined from each of the first and second field of indicating precoding information and layer number can be one of the available precoding matrixes. The bit width of each field of “precoding information and layer number” will be 4, and thus, the total bit width of the two fields of “precoding information and layer number” will be 8; or
if maxRank is 4 supporting rank combination (1+3) or (3+1), the available precoding matrixes for NCJT PUSCH are TPMI index with 0-3 and 13 in Table 6.3.1.5-3 for single-layer transmission using four antenna ports, TPMI index with 0-6 in Table 6.3.1.5-5 for two-layer transmission using four antenna ports and TPMI index with 0-1 in Table 6.3.1.5-6 for three-layer transmission using four antenna ports. The precoding matrix determined from each of the first and second field of indicating precoding information and layer number can be one of the available precoding matrixes. The bit width of each field of “precoding information and layer number” will be 4, and thus, the total bit width of the two fields of “precoding information and layer number” will be 8.

In addition, since the field of indicating precoding information and layer number can be configured in various manners in view of different scenarios and schemes, to support dynamic switching between NCJT PUSCH and non-NCJT PUSCH, such as S-TRP PUSCH or M-TRP PUSCH repetition, the bit width of each field of indicating precoding information and layer number will be determined according to maximum bit width of field(s) of indicating precoding information and layer number of all PUSCH schemes which support dynamic switching.

As illustrated above, according to some embodiments of the present application, only one field of “precoding information and layer number” or enhanced field of “precoding information and layer number” will be included in the corresponding DCI or in the corresponding RRC configuration of a PUSCH. Since there are two fields of precoding information for M-TRP PUSCH repetition, only dynamic switching between S-TRP PUSCH and NCJT PUSCH will be supported. The bit width of the only one field is the maximum of a bit width expected for the NCJT PUSCH and a bit width expected for the S-TRP PUSCH. The bit width expected for the NCJT PUSCH is the bit width needed only for the NCJT PUSCH, e.g., the bit width illustrated above in details, and the bit width expected for the S-TRP PUSCH is the bit width needed only for the S-TRP PUSCH, e.g., the bit width specified in legacy specification.

In the case that there are two valid fields of “precoding information and layer number” for NCJT PUSCH, according some embodiments of the present application, dynamic switching between S-TRP PUSCH and NCJT PUSCH is supported but dynamic switching between M-TRP PUSCH repetition and NCJT PUSCH is not supported. Then, a bit width of a first field of the two configuration fields is the maximum of a bit width expected for the NCJT PUSCH and a bit width expected for S-TRP PUSCH, and a bit width of a second field of the two configuration fields is a bit width expected for the NCJT PUSCH.

According to some other embodiments of the present application, dynamic switching among S-TRP PUSCH, M-TRP PUSCH repetition and NCJT PUSCH will be supported in the case that there is only one valid field of “precoding information and layer number” for NCJT PUSCH. Then, a bit width of a first field of the two configuration fields is a maximum of a bit width expected for the NCJT PUSCH and a bit width expected for the S-TRP PUSCH, and a bit width of a second field of the two configuration fields is a bit width expected for the M-TRP PUSCH repetition.

According some yet other embodiments of the present application, in the case that there are two valid fields of “precoding information and layer number”, while dynamic switching among S-TRP PUSCH, M-TRP PUSCH repetition and NCJT PUSCH is supported. Then, a bit width of a first field of the two fields is a maximum of a bit width expected for the NCJT PUSCH and a bit width expected for the S-TRP PUSCH, and a bit width of a second field of the two fields is a maximum of a bit width expected for the M-TRP PUSCH repetition and a bit width expected for the NCJT PUSCH.

Besides the methods, embodiments of the present application also propose an apparatus of uplink transmission.

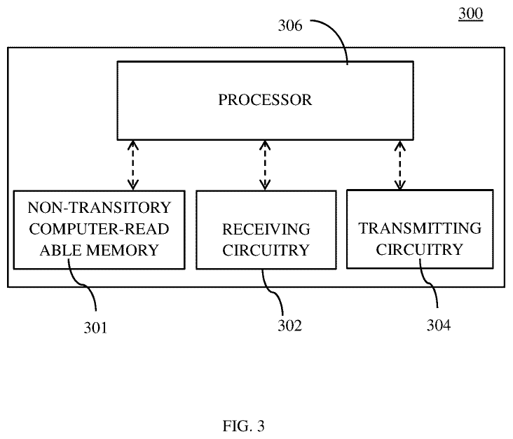

For example, FIG. 3 illustrates a block diagram of an apparatus of uplink transmission 300 according to some embodiments of the present application.

As shown in FIG. 3, the apparatus 300 may include at least one non-transitory computer-readable medium 301, at least one receiving circuitry 302, at least one transmitting circuitry 304, and at least one processor 306 coupled to the non-transitory computer-readable medium 301, the receiving circuitry 302 and the transmitting circuitry 304. The at least one processor 306 may be a CPU, a DSP, a microprocessor etc. The apparatus 300 may be a RAN node, e.g., a gNB or a remote apparatus, e.g., UE configured to perform a method illustrated in the above or the like.

Although in this figure, elements such as the at least one processor 306, transmitting circuitry 304, and receiving circuitry 302 are described in the singular, the plural is contemplated unless a limitation to the singular is explicitly stated. In some embodiments of the present application, the receiving circuitry 302 and the transmitting circuitry 304 can be combined into a single device, such as a transceiver. In certain embodiments of the present application, the apparatus 300 may further include an input device, a memory, and/or other components.

In some embodiments of the present application, the non-transitory computer-readable medium 301 may have stored thereon computer-executable instructions to cause a processor to implement the method with respect to the network apparatus as described above. For example, the computer-executable instructions, when executed, cause the processor 306 interacting with receiving circuitry 302 and transmitting circuitry 304, so as to perform the steps with respect to the RAN node or network apparatus, e.g., a gNB as depicted above.

In some embodiments of the present application, the non-transitory computer-readable medium 301 may have stored thereon computer-executable instructions to cause a processor to implement the method with respect to the UE as described above. For example, the computer-executable instructions, when executed, cause the processor 306 interacting with receiving circuitry 302 and transmitting circuitry 304, so as to perform the steps with respect to the UE as illustrated above.

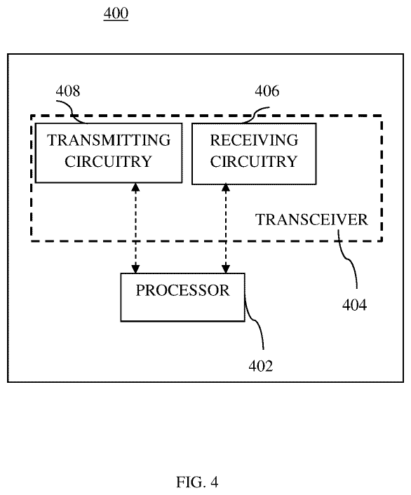

FIG. 4 is a block diagram of an apparatus of uplink transmission according to some other embodiments of the present application.

Referring to FIG. 4, the apparatus 400, for example a gNB or a UE may include at least one processor 402 and at least one transceiver 404 coupled to the at least one processor 402. The transceiver 404 may include at least one separate receiving circuitry 406 and transmitting circuitry 404, or at least one integrated receiving circuitry 406 and transmitting circuitry 404. The at least one processor 402 may be a CPU, a DSP, a microprocessor etc.

According to some embodiments of the present application, when the apparatus 400 is a remote apparatus, e.g., a UE, the UE is configured to: receive first configuration information indicating two SRS resource sets for PUSCH transmissions; receive second configuration information including one or two configuration fields of indicating precoding information and layer number for a PUSCH, wherein the PUSCH is a PUSCH of a first scheme or a PUSCH of a scheme different from the first scheme, wherein in the case that the PUSCH is the PUSCH of the first scheme, a first set of layers of the PUSCH is associated with a first SRS resource set of the two SRS resource sets and a second set of layers of the PUSCH which are remaining layers except for the first set of layers of the PUSCH is associated with a second SRS resource set of the two SRS resource sets, and both a number of the first set of layers and a number of the second set of layers are equal to or larger than 1; and transmit the PUSCH with precoding information determined at least according to the one or two configuration fields, a maximum SRS resource port number of the two SRS resource sets, a number of PUSCH antenna port for the PUSCH, a configured maximum rank for the PUSCH, and whether the PUSCH is the PUSCH of the first scheme or the PUSCH of a scheme different from the first scheme.

According to some other embodiments of the present application, when the apparatus 400 is a RAN node, e.g., a gNB, the RAN node may be configured to: transmit first configuration information indicating two SRS resource sets for PUSCH transmissions; transmit second configuration information including one or two configuration fields of indicating precoding information and layer number for a PUSCH, wherein the PUSCH is a PUSCH of a first scheme or a PUSCH of a scheme different from the first scheme, wherein in the case that the PUSCH is the PUSCH of the first scheme, a first set of layers of the PUSCH is associated with a first SRS resource set of the two SRS resource sets and a second set of layers of the PUSCH which are remaining layers except for the first set of layers of the PUSCH is associated with a second SRS resource set of the two SRS resource sets, and both a number of the first set of layers and a number of the second set of layers are equal to or larger than 1; and receive the PUSCH, wherein the PUSCH is transmitted with precoding information determined at least according to the one or two configuration fields, a maximum SRS resource port number of the two SRS resource sets, a number of PUSCH antenna port for the PUSCH, a configured maximum rank for the PUSCH, and whether the PUSCH is the PUSCH of the first scheme or the PUSCH of a scheme different from the first scheme.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A user equipment (UE) for wireless communication, comprising:
at least one memory; and
at least one processor coupled with the at least one memory and
configured to cause the UE to:
receive first configuration information that indicates two sounding reference signal (SRS) resource sets for physical uplink shared channel (PUSCH) transmissions;
receive second configuration information that includes one or two configuration fields that indicate precoding information and layer number for a PUSCH, wherein the PUSCH is a PUSCH of a first scheme or a PUSCH of a second scheme, wherein the second scheme is different from the first scheme, wherein in a case that the PUSCH is the PUSCH of the first scheme, a first set of layers of the PUSCH is associated with a first SRS resource set of the two SRS resource sets and a second set of layers of the PUSCH which are remaining layers except for the first set of layers of the PUSCH is associated with a second SRS resource set of the two SRS resource sets, and both a number of the first set of layers and a number of the second set of layers are equal to or larger than 1; and
transmit the PUSCH with precoding information determined at least according to the one or two configuration fields, a maximum SRS resource port number of the two SRS resource sets, a number of PUSCH antenna port for the PUSCH, a configured maximum rank for the PUSCH, and whether the PUSCH is the PUSCH of the first scheme or the PUSCH of the second scheme.

2. The UE of claim 1, wherein, in a case that the maximum SRS resource port number is 1, a demodulation reference signal (DMRS) port for the PUSCH is determined from another configuration field that indicates the DMRS port in the second configuration information, wherein the DMRS port is determined for the PUSCH of the first scheme according to a rank of 2 and is determined for the PUSCH of the second scheme according to a rank of 1.

3. The UE of claim 1, wherein the maximum SRS resource port number and the number of PUSCH antenna port are 2, wherein a real maximum rank determined for the PUSCH of the first scheme based on the configured maximum rank is 2, wherein the PUSCH is the PUSCH-1 in the first scheme, and wherein there is only one configuration field indicating a transmitted precoding matrix indicator (TPMI) index, the number of the first set of layers of the PUSCH, and the second set of layers of the PUSCH, or there are two configuration fields but only one is a valid field for the PUSCH of the first scheme indicating the TPMI index, the number of the first set of layers of the PUSCH and the number of the second set of layers of the PUSCH, and wherein:
the TPMI index is one of TPMI index with 0-2 for two-layer transmission using two antenna ports in a case that codebookSubset is configured to fullyAndPartialAndNonCoherent and ul-FullPowerTransmission is not configured or configured to fullpowerMode2 or configured to fullpower; or
the TPMI index is one of TPMI index with 0 for two-layer transmission using two antenna ports in a case that codebookSubset is configured to nonCoherent.

4. The UE of claim 1, wherein the maximum SRS resource port number and the number of PUSCH antenna port are 2, wherein a real maximum rank determined for the PUSCH of the first scheme based on the configured maximum rank is 2, wherein the PUSCH is the PUSCH of the first scheme, and wherein there are two configuration fields, a first field of the two configuration fields indicates the number of the first set of layers and a first transmitted precoding matrix indicator (TPMI) index for the first set of layers and a second field of the two configuration fields indicates the number of the second set of layers and a second TPMI index for the second set of layers, and wherein:
in a case that codebookSubset is configured to fullyAndPartialAndNonCoherent and ul-FullPowerTransmission is not configured or configured to fullpowerMode2 or configured to fullpower, each of the first TPMI index and second TPMI index is one of TPMI index with 0-5 for single-layer transmission using two antenna ports;
in a case that codebookSubset is configured to nonCoherent and ul-FullPowerTransmission is not configured or configured to fullpowerMode2 or configured to fullpower, each of the first TPMI index and second TPMI index is one of TPMI index with 0-1 for single-layer transmission using two antenna ports; or
in a case that codebookSubset is configured to nonCoherent and ul-FullPoweiTransmission is configured to fullpowerModel, each of the first TPMI index and second TPMI index is one of TPMI index with 0-2 for single-layer transmission using two antenna ports.

5. The UE of claim 1, wherein the maximum SRS resource port number is 2, the number of PUSCH antenna port is 4, the PUSCH is the PUSCH of the first scheme, wherein a first PUSCH antenna port and a third PUSCH antenna port are two SRS resource ports of a first associated SRS resource of the PUSCH within the first SRS resource set of the two SRS resource sets for transmitting the first set of layers of the PUSCH, and a second PUSCH antenna port and a fourth PUSCH antenna port are two SRS resource ports of a second associated SRS resource of the PUSCH within the second SRS resource set of the two SRS resource sets for transmitting the second set of layers of the PUSCH.

6. (canceled)

7. (canceled)

8. The UE of claim 1, wherein the maximum SRS resource port number is 2, the number of PUSCH antenna port is 4, and the PUSCH is the PUSCH of the first scheme, wherein two PUSCH antenna ports are two SRS resource ports of a first associated SRS resource of the PUSCH within the first SRS resource set of the two SRS resource sets for transmitting the first set of layers of the PUSCH, and a remaining two PUSCH antenna ports are two SRS resource ports of the second associated SRS resource of the PUSCH within a second SRS resource set of the two SRS resource sets for transmitting the second set of layers of the PUSCH.

9. (canceled)

10. (canceled)

11. The UE of claim 1, wherein the maximum SRS resource port number is 2, the number of PUSCH antenna port is 4, the PUSCH is the PUSCH of the first scheme, wherein a first PUSCH antenna port and a second PUSCH-antenna port are two SRS resource ports of a first associated SRS resource of the PUSCH within the first SRS resource set of the two SRS resource sets for transmitting the first set of layers of the PUSCH, and a third PUSCH antenna port and a fourth PUSCH antenna port are two SRS resource ports of a second associated SR S resource of the PUSCH within the second SRS resource set of the two SRS resource sets for transmitting the second set of layers of the PUSCH.

12. (canceled)

13. (canceled)

14. (canceled)

15. The UE of claim 1, wherein in a case that there is only one configuration field or there are two configuration fields but only one is valid field for a PUSCH with the first scheme, a bit width of the only one configuration field or the valid field is a maximum of a bit width expected for the PUSCH of the first scheme and a bit width expected for the PUSCH of the second scheme that is always associated with one SRS resource set of the two SRS resource sets.

16. The UE of claim 1, wherein in a case that there are two configuration fields, a bit width of a first field of the two configuration fields is a maximum of a bit width expected for the PUSCH of the first scheme and a bit width expected for the PUSCH of the second scheme that is always associated with one SRS resource set of the two SRS resource sets, and a bit width of a second field of the two configuration fields is a bit width expected for the PUSCH of the first scheme.

17. The UE of claim 1, wherein in a case that there are two configuration fields, a bit width of a first field of the two configuration fields is a maximum of a bit width expected for the PUSCH of the first scheme and a bit width expected for the PUSCH of the second scheme that is always associated with one SRS resource set of the two SRS resource sets, and a bit width of a second field of the two configuration fields is a bit width expected for the PUSCH of the second scheme that is indicated as a repetition Type A or B PUSCH with repetition number larger than 1 and is indicated to be associated with the two SRS resource sets.

18. The UE of claim 1, wherein in a case that there are two configuration fields, a bit width of a first field of the two configuration fields is a maximum of a bit width expected for the PUSCH of the first scheme and a bit width expected for the PUSCH in the second scheme that is always associated with one SRS resource set of the two SRS resource sets, and a bit width of a second field of the two configuration fields is a maximum of a bit width expected for the PUSCH of the second scheme that is indicated as a repetition Type A or B PUSCH with repetition number larger than 1 and indicated to be associated with the two SRS resource sets and a bit width expected for the PUSCH of the first scheme.

19. The UE of claim 1, wherein in a case that only one maximum rank is configured for PUSCH transmissions, a real maximum rank for determining the precoding information for the PUSCH of the first scheme is the configured maximum rank, and a real maximum rank for determining the precoding information for the PUSCH of the second scheme is a smaller one between the maximum SRS resource port number and the configured maximum rank.

20. The UE of claim 1, wherein in a case that two maximum ranks are respectively configured for a PUSCH of the first scheme and a PUSCH of the second scheme, a real maximum rank for determining the precoding information for the PUSCH is the configured maximum rank associated with a PUSCH scheme of the PUSCH.

21. The UE of claim 1, wherein in a case that only one maximum rank is configured for PUSCH transmissions, a real maximum rank for determining the precoding information for the PUSCH of the first scheme is a smaller one between a predefined maximum rank for the PUSCH of the first scheme and a double of the configured maximum rank, and a real maximum rank for determining the precoding information for the PUSCH of the second scheme is the configured maximum rank.

22. A base station for wireless communication, comprising:
at least one memory; and
at least one processor coupled with the at least one memory and
configured to cause the base station to:
transmit first configuration information that indicates two sounding reference signal (SRS) resource sets for physical uplink shared channel (PUSCH) transmissions;
transmit second configuration information that includes one or two configuration fields that indicate precoding information and layer number for a PUSCH, wherein the PUSCH is a PUSCH of a first scheme or a PUSCH of a second scheme wherein the second scheme is different from the first scheme, wherein in a case that the PUSCH is the PUSCH of the first scheme, a first set of layers of the PUSCH is associated with a first SRS resource set of the two SRS resource sets and a second set of layers of the PUSCH which are remaining layers except for the first set of layers of the PUSCH is associated with a second SRS resource set of the two SRS resource sets, and both a number of the first set of layers and a number of the second set of layers are equal to or larger than 1; and
receive the PUSCH, wherein the PUSCH is transmitted with precoding information determined at least according to the one or two configuration fields, a maximum SRS resource port number of the two SRS resource sets, a number of PUSCH antenna port for the PUSCH, a configured maximum rank for the PUSCH, and whether the PUSCH is the PUSCH of the first scheme or the PUSCH of the second scheme.

23. (canceled)

24. A processor for wireless communication, comprising:
at least one controller coupled with at least one memory and configured to cause the processor to:
receive first configuration information that indicates two sounding reference signal (SIRS) resource sets for physical uplink shared channel (PUSCH) transmissions;
receive second configuration information that includes one or two configuration fields that indicate precoding information and layer number for a PUSCH, wherein the PUSCH is a PUSCH of a first scheme or a PUSCH of a second scheme, wherein the second scheme is different from the first scheme, wherein in a case that the PUSCH is the PUSCH of the first scheme, a first set of layers of the PUSCH is associated with a first SRS resource set of the two SRS resource sets and a second set of layers of the PUSCH which are remaining layers except for the first set of layers of the PUSCH is associated with a second SRS resource set of the two SRS resource sets, and both a number of the first set of layers and a number of the second set of layers are equal to or larger than 1; and
transmit the PUSCH with precoding; information determined at least according to the one or two configuration fields, a maximum SRS resource port number of the two SRS resource sets, a number of PUSCH antenna port for the PUSCH, a configured maximum rank for the PUSCH, and whether the PUSCH is the PUSCH of the first scheme or the PUSCH of the second scheme.

25. The processor of claim 24, wherein, in a case that the maximum SRS resource port number is 1, a demodulation reference signal (DMRS) port for the PUSCH is determined from another configuration field that indicates the DMRS port in the second configuration information, wherein the DMRS port is determined for the PUSCH of the first scheme according to a rank of 2 and is determined for the PUSCH of the second scheme according to a rank of 1.

26. The processor of claim 24, wherein the maximum SRS resource port number is 2, the number of PUSCH antenna port is 4, the PUSCH is the PUSCH of the first scheme, wherein a first PUSCH antenna port and a third PUSCH antenna port are two SRS resource ports of a first associated SRS resource of the PUSCH within the first SRS resource set of the two SRS resource sets for transmitting the first set of layers of the PUSCH, and a second PUSCH antenna port and a fourth PUSCH antenna port are two SRS resource ports of a second associated SRS resource of the PUSCH within the second SRS resource set of the two SRS resource sets for transmitting the second set of layers of the PUSCH.

27. A method performed by a user equipment (UE), the method comprising:
receiving first configuration information that indicates two sounding reference signal (SRS) resource sets for physical uplink shared channel (PUSCH) transmissions;
receiving second configuration information that includes one or two configuration fields that indicate precoding information and layer number for a PUSCH, wherein the PUSCH is a PUSCH of a first scheme or a PUSCH of a second scheme, wherein the second scheme is different from the first scheme, wherein in a case that the PUSCH is the PUSCH of the first scheme, a first set of layers of the PUSCH is associated with a first SRS resource set of the two SRS resource sets and a second set of layers of the PUSCH which are remaining layers except for the first set of layers of the PUSCH is associated with a second SRS resource set of the two SRS resource sets, and both a number of the first set of layers and a number of the second set of layers are equal to or larger than 1; and
transmitting the PUSCH with precoding information determined at least according to the one or two configuration fields, a maximum SRS resource port number of the two SRS resource sets, a number of PUSCH antenna port for the PUSCH, a configured maximum rank for the PUSCH, and whether the PUSCH is the PUSCH of the first scheme or the PU SCH of the second scheme.

28. The method of claim 27, wherein, in a case that the maximum SRS resource port number is 1, a demodulation reference signal (DMRS) port for the PUSCH is determined from another configuration field that indicates the DMRS port in the second configuration information, wherein the DMRS port is determined for the PUSCH of the first scheme according to a rank of 2 and is determined for the PUSCH of the second scheme according to a rank of 1.
